(19) United States
(12) Patent Application Publication
(10) Pub. No.: US 2015/0317728 A1
(43) Pub. Date: Nov. 5, 2015

(54) MORTGAGE SYNTHESIS AND AUTOMATION

(71) Applicant: BeSmartee, Inc., Huntington Beach, CA (US)

(72) Inventor: Thien K. Nguyen, Huntington Beach, CA (US)

(21) Appl. No.: 14/704,798

(22) Filed: May 5, 2015

Related U.S. Application Data
(60) Provisional application No. 61/988,696, filed on May 5, 2014.

(51) Int. Cl. G06Q 40/02

(52) U.S. Cl. CPC G06Q 40/025

(57) ABSTRACT

A system and methods are provided to enable a user to apply to multiple mortgage lenders, receive real-time loan approvals from said lenders, and complete the acquisition of a mortgage loan via a series of electronic communications via network-accessible computing systems. A mortgage application is automatically generated using intelligent synthesis of data received from multiple sources based on limited personal data manually provided by the user, such as a name, date of birth, social security number and access to financial accounts. The generated mortgage application may be submitted to multiple lenders' automated underwriting systems and loan pricing engines. Multiple lenders' decisions may then be received and provided to the user, so that the user may select from multiple available mortgage loans.

### BACKGROUND

1. Field

This disclosure generally relates to an online mortgage lending platform.

2. Description of the Related Art

Over the last several years, consumers have increasingly turned to the Internet for information, including information related to housing and real estate property purchases. Various attempts have been made to satisfy the needs of current and prospective homeowners by providing information related to mortgage lending options when such consumers decide to purchase a parcel of real estate, including attempts to provide online mortgage lending. However, all of these attempts suffer from various deficiencies, such as failing to provide access to “lockable” loan approvals (and thereby failing to provide the consumer with credible and accurate lending decisions in real-time); failing to provide a consumer user with the ability to apply to multiple lenders; failing to provide visibility into all lenders and all lenders' loans; failing to allow the user to complete the entire loan process online in a timely manner or with multiple lenders; and other problems.

It is desirable to have a consumer mortgage lending platform which makes it easy for a consumer to get a mortgage loan entirely online; to complete a mortgage application efficiently and by manually providing only limited information; to apply to multiple lenders using the same mortgage application; to provide information regarding all loans for which the consumer qualifies from each lender to whom the consumer applies; and to provide users the ability to complete or “close” a loan entirely online with as little friction as possible. Additionally, it would be advantageous to mortgage lenders, investors and government agencies to have a mortgage application that is automated, hands-free, accurate and trusted.

### BRIEF SUMMARY

The present disclosure describes techniques to enable a user to apply to multiple lenders, receive real-time loan approvals from said lenders, and close said loans entirely online. For a user to apply to multiple lenders, the user may verify a mortgage application that is automatically generated using intelligent synthesis of data received from multiple sources. The generated mortgage application may include supporting documents of information within the mortgage application and submitted to multiple lenders' automated underwriting systems and loan pricing engines (e.g., a Product Eligibility & Pricing Engine or “PPE”). Multiple lenders' decisions may then be automatically received and provided to the user for which the mortgage application was generated, so that the user may select from multiple available mortgage loans. In order to have the mortgage automatically generated in this manner, the user may only need to provide limited personal data, such as a name, date of birth, social security number and access to financial accounts, and may optionally provide additional access to particular supplemental data sources, such as one or more social media accounts. In certain implementations, some or all of the techniques may be performed by a Mortgage Application Automation (“MAA”) system, as described in greater detail below.

Advantages of the techniques described herein may, in some respects, allow the borrower to take certain roles traditionally fulfilled by a loan officer, and may include enabling the user to: anonymously search for loan programs from multiple lenders; have a mortgage application automatically generated; apply to multiple lenders; receive lockable loan decisions from multiple lenders; reduce the time and effort required to identify, gather and locate documentation; fulfill loan conditions; monitor real-time loan status; reduce the time and effort required to attain a mortgage loan; generate the Initial Disclosures associated with a selected loan; order an appraisal; schedule the notary public online; and facilitate third-party transactions as needed.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a networked environment that includes a Mortgage Application Automation (“MAA”) system as well as various computing systems associated with one or more third-party data source vendors, with one or more other vendors, with one or more applicant users of the MAA system, and with various information providers.

FIG. 2 illustrates a server computing system suitable for executing an implementation of an MAA system that performs at least some of the described techniques.

FIGS. 3A-3AE depict certain portions of a Graphical User Interface (GUI) that may be provided to enable various applicant interactions with an MAA system, according to one illustrated implementation.

FIGS. 4A-4G depict certain workflow diagrams of certain processes according to an example implementation of an MAA system performing at least some of the described techniques.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computing systems, including client and server computing systems and networks (including packet switching networks and related infrastructure) as well as other communications channels, have not been shown or described in detail to avoid unnecessarily obscuring descriptions of the implementations.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise. Also as used herein, the terms “user,” “applicant,” “mortgage applicant,” and “borrower” may be used interchangeably unless context clearly indicates otherwise.

The headings provided herein are for convenience only and do not interpret the scope or meaning of the implementations.

### System Overview

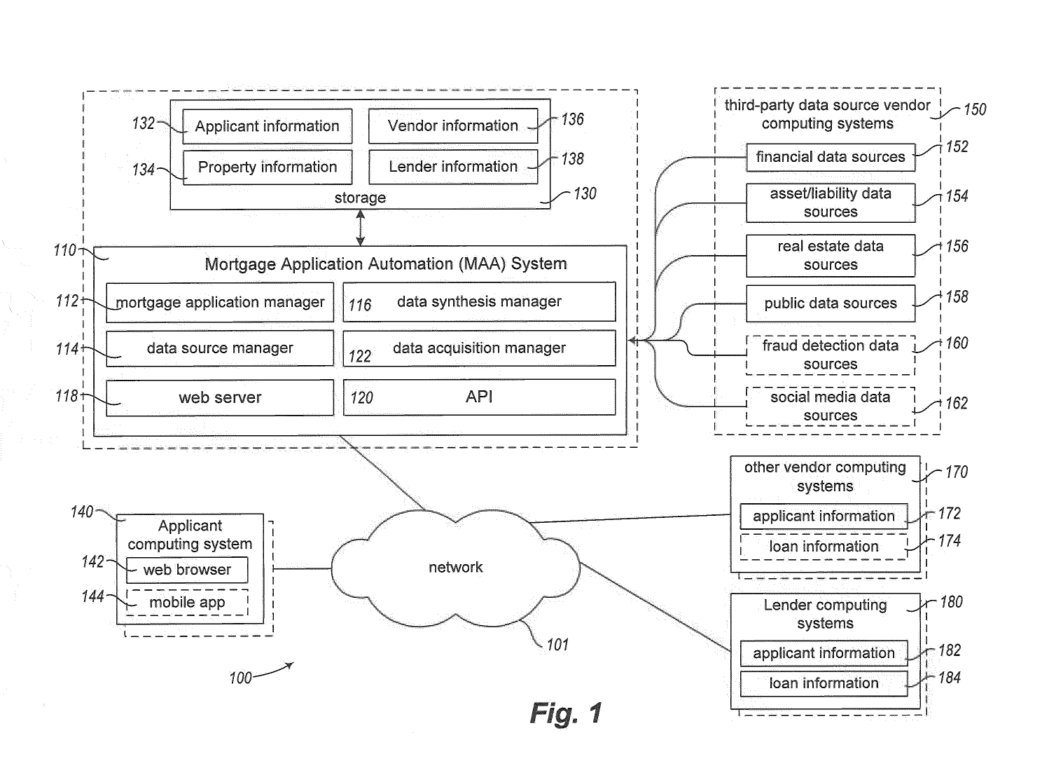

FIG. 1 is a schematic diagram of a networked environment 100 that includes a Mortgage Application Automation (“MAA”) system 110 and further includes various computing systems associated with one or more third-party data source vendors, with one or more other vendors, with one or more applicant users of the MAA system, and with one or more mortgage lenders.

The illustrated example of FIG. 1 includes computing systems 140 associated with one or more applicant users, computing systems 180 associated with one or more lender users, computing systems 150 associated with one or more third-party data source vendors, and computing systems 170 associated with one or more other vendors, each of which may be interacting at various times with an implementation of the Mortgage Application Automation system 110. In the depicted implementation, vendor computing systems 170 include applicant information 172 and loan information 174; lender computing systems 180 include applicant information 182 and loan information 184. The MAA system is communicatively coupled to such computing systems via one or more computer networks 101, and is additionally communicatively coupled to non-transitory electronic storage 130, which includes applicant information 132, property information 134, vendor information 136, and lender information 138. In certain implementations, the electronic storage may be operated by an entity that also operates the MAA system; in other implementations the MAA system may utilize secure storage via a third-party storage service or in some other manner, and may operate locally with respect to the MAA or remotely via intervening networks 101.

The MAA system may exchange various electronic communications with client computing systems 140 associated with applicant users in order to provide various functionality to such users. In certain implementations, the MAA system may support operations via one or more computing systems to enable each of multiple mortgage applicant users respectively associated with computing systems 140 to apply to multiple mortgage lenders, receive loan approvals from said mortgage lenders, and close a loan from said lender entirely online. In particular, the platform may allow a user to perform an anonymous search of available loans, obtain a full mortgage application generated automatically, gather required mortgage application documents, apply to multiple lenders, receive real lockable loan programs, pricing and approvals from said lenders, choose a loan and lender, order an appraisal of property, pay for the appraisal, track real-time status of loan, satisfy any underwriting conditions, receive final loan documents, schedule a notary signing and close the loan entirely online. The system may also provide the lender with a platform to receive said mortgage application and deliver results back to the user. The system also provides vendors with a platform to receive order requests and deliver results back to the user.

In the depicted implementation, the MAA system 110 includes a mortgage application manager 112, a data source manager 114, a data synthesis manager 116, a data acquisition manager 122, a Web server 118, and an API (“Application Program Interface”) 120. In this and various other implementations, the data synthesis manager 116 provides intelligent synthesis of data received from applicants, lenders, and vendors, such as by the data acquisition manager 122. For example, raw data received by the MAA system via the data acquisition manager may include similar data from multiple sources, such as if a particular vendor provides a credit report associated with the name “John Smith” when the applicant has self-identified as “Jon Smith.” Similarly, a second vendor may have provided credit history for the spelling variation “Jon Smithe.” Automated information synthesis logic provided by the MAA system via the data synthesis manager 116 may provide a confidence rating for each source (and, in certain implementations, each data point) in order to weight the received raw data so as to predict which data source and received data point is more accurate. Moreover, in an implementation the MAA system may modify the information synthesis logic over time (such as in response to feedback and/or performance metrics regarding existing or earlier mortgage applications and the loans resulting from such mortgage applications) in order to improve the accuracy of future generated mortgage applications. For example, if data received from Vendor A is later determined to be inaccurate, the MAA system may associate future data received from Vendor A with lower confidence ratings, or may determine not to accept data from Vendor A at all.

In the depicted implementation of FIG. 1, the data acquisition manager 122 of the MAA system may receive raw data from various third-party data source vendor computing systems 150. These include one or more of financial data sources 152; asset/liability data sources 154; real estate data sources 156; public data sources 158; fraud detection data sources 160; and social media data sources 162.

The MAA system may include distinct platforms intended for the respective use of applicants, lenders, and vendors, as described below. For example, in certain implementations, the MAA system may provide distinct user interfaces for mortgage applicants, vendors, and lenders, and each user interface may be provided by one or more web sites operated by the MAA system (such as may be provided by Web server 118 of FIG. 1). In at least some implementations, such distinct user interfaces may be designed for desktop, tablet and mobile devices, and may also include one or more mobile applications for various mobile device operating systems, such as the iOS and Android operating systems. For example, in the illustrated implementation of FIG. 1, Applicant computing system 140 includes a web browser 142, and may additionally include a mobile application 144 associated with the MAA system.

The applicant user interface may include multiple components in order to provide various aspects, as follows:
Learning, which may include providing the applicant user with knowledge-based content (either text, visual, video, audio or a combination thereof) designed to educate the user regarding mortgage lending overall, including the process (traditional and via the MAA system), the terminology, the opinions, the lenders, the vendors, the investors, the law, and the entire eco-system of participants, all with the intent of helping the user become an informed user.
Searching, which may include one or more interface elements to enable the applicant user to provide information such as their ZIP code, purchase price, down payment, and credit rating, etc. The search criteria, along with additional assumed search criteria not initially requested of the user (e.g., property type, property use, construction status, bankruptcy status, and foreclosure status) may be submitted to multiple lenders' pricing engines, with results being returned by the lenders' servers, received by the system and displayed to the user, with options to adjust their original search criteria, and now with the option to adjust the additional assumed search criteria not originally requested of the user.
Application, which may include enabling the user to create a free account. The account may be based on the user's first name, last name, phone, email and password, or other identifying information. In at least some implementations, the user may provide additional personal data (e.g., date of birth, social security number, address of property and acknowledgement & agreement to terms). Based on such information, the MAA system may additionally request validation data (such as information appearing on the user's credit report) from a third-party vendor, which may be used to confirm the identity of the user by posing a series of questions to the user regarding such information and requiring the user to answer such questions within a predetermined amount of time. In other implementations, the user's identity may be established in some other manner. The user may be required to provide at least informational access to the user's financial accounts, such as by providing login credentials for one or more of the user's financial accounts. In certain implementations, such login credentials may be delivered to a financial accounts data vendor, which connects to the user's financial accounts to determine whether the relevant financial accounts may be accessed using the provided information. Upon successful access, the user is taken to the next step, which is the automatic creation of the user's mortgage application. The personal identifying information provided by the user is used to query vendors such as credible third-party data providers (e.g., credit report data providers, fraud detection data providers, aggregated financial asset/liability and banking data providers, property data, MLS data and social media data, etc.) to collect all additional information for generating a mortgage application. In at least some implementations, the generated mortgage application may be provided along with a certification and PDF document of the data as a complete mortgage application. Furthermore, in certain implementations, the certification of the generated mortgage application may include an indication of one or more confidence ratings regarding information provided as part of the complete mortgage application (such as a numerical, percentage or other rating indicating a confidence level with respect to an applicant's reported income, employment history, etc.).
Results, which may include displaying results from the MAA system electronic submission of some or all of the generated mortgage application to multiple lenders' automated underwriting systems and loan pricing engines, such as automated underwriting systems (AUS) and loan pricing engines (LP or PE) operated by mortgage lenders. In certain implementations, the generated mortgage application may be submitted to multiple lenders simultaneously. In other implementations, the generated mortgage application may be submitted to multiple lenders in turn, such as based on user interaction with a GUI associated with the MAA system (which may allow the user to individually select lenders, one at a time, to which the generated mortgage application is to be submitted by the MAA system). In certain implementations, the MAA system may display all or a subset of loans for which the user has been approved to the user, and may filter or sort such display according to one or more “Best Match” algorithms, such as according to criteria determined for the particular user based on interactions of the user with the MAA system or other systems. For example, such filtering algorithms may be based at least in part on interactions or preferences of the user indicating one or more priorities for that user (e.g., low costs, low fees, or other appropriate factors). Mortgage applications submitted to AUS, LP or PE are typically verified for accuracy, certified by third-party vendors, and autonomously determined to be credible enough to warrant automatically providing to a user a “lockable” loan approval. A “lockable” loan is a commitment from a lender to lend on the terms disclosed assuming that the data within the mortgage application is accurate, verifiable and complete. Results may further include enabling a user to select from multiple mortgage loan offers.
Initial Disclosures, which may include the MAA system generating such Disclosures with respect to each of one or more loans selected by the user from a larger plurality of loans displayed (in Results, described elsewhere herein) as being available for that user. The content of such Initial Disclosures may, in certain scenarios and implementations, be dictated by local, regional, or other laws and regulations. The Initial Disclosures typically include information for the user as to expected costs associated with the selected loan; monthly payments expected to be associated with the selected loan; and details regarding any loan structure associated with the selected loan (such as whether the selected loan is fixed, adjustable, is associated with one or more balloon payments, etc.). In various implementations, the MAA system may automate the collection of information for the Initial Disclosures.
Closing may in at least some implementations include the ordering of an appraisal report in order to proceed with a particular mortgage loan offer selected by the user. Such an appraisal report is typically paid for upfront by the borrower. The order for the appraisal is then submitted to the lender's choice of appraisal vendor for fulfillment, whereupon loan conditions (requests that need to be fulfilled) may be automatically generated by the lender. In certain implementations, an underwriter may review the mortgage application and “condition” the loan by specifying additional loan conditions which may need to be fulfilled in order for the selected loan to be issued. In certain implementations, loan documents may then be generated and delivered to the user online, so that the user may review the loan documents and, if satisfactory, schedule via the MAA system a physical or electronic notary signing. In such implementations, an order is submitted to the lender's choice of notary agent, wherein the notary agent or representatives confirm the order and fulfill the request. Once the loan documents are signed and delivered to the settlement vendor, the closing process may commence, which includes the title agent executing the mortgage loan according to the loan instructions.

As indicated above, mortgage applicant users may interact with implementations of the MAA system for various reasons, including but not limited to: searching for loans anonymously; automatically generating a mortgage application; applying for loans from multiple lenders; retrieving lending decisions from multiple lenders; selecting a particular mortgage loan and lender associated with that mortgage loan; ordering an appraisal from the lender's choice of appraisal vendor; receiving notifications of real-time loan status information; fulfilling loan conditions and/or notifying a lender that loan conditions have been fulfilled; scheduling a physical or electronic notary signing; closing their loan entirely online; obtaining data and services provided by vendors; and obtaining information regarding lending decisions provided by lenders.

In various implementations, the MAA system may utilize and request various information to generate a complete mortgage application. In certain implementations, an applicant user may need to provide less personal data if new data sources with more data or more reliable data sources are found. In other implementations, the applicant user may need to provide more personal data if existing data provider vendors cease operations or are otherwise inaccessible, or if particular mortgage lenders require additional data. In at least some implementations, such personal data may not be obtained by the MAA system from the applicant user at all, or may be obtained by the MAA system via a combination of the user and one or more additional entities. In generating the mortgage application, in certain implementations the MAA system may require the user to provide additional data if such data cannot be obtained from one or more data provider vendors from which such data is typically obtained. The mortgage application automatically generated, or portions of the generated mortgage application, may not need to be verified by the borrower as data sources become more plentiful, accurate and trusted. The mortgage application in its traditional form may no longer be required as lending practices change, such as if the lender can make lending decisions using fragmented data pieced together from various sources, rather than a complete loan application and file in use today. Loan approval decisions from lenders may not be required if loan decisions are made by a source other than the lender. Appraisal ordering may not be required, such as in certain implementations in which such appraisals are not required for particular types of mortgage loans, or if real estate valuations may be performed in another manner. In certain implementations, closing conditions may not be required if lending practices, and/or technology changes eliminate the need for any loan conditions because lending decisions are instant or automatically made by machine and do not require additional verification of data or automated decisions. In an implementation, scheduling a notary signing may not be required if such notary signing is performed electronically, or if user identity may be reliably established in some other manner. In certain implementations, the techniques described herein may be applied to additional types of loans, including but not limited to automobile, boat, airplane, medical, education, personal, business and any other type of loan that requires a lender to make a decision using a loan application. In an implementation, the MAA system may be associated with and/or operated by one or more mortgage lenders or other entities.

The MAA system may exchange various electronic communications with lender computing systems 180 associated with lender users in order to provide various functionality to such users. The lender user interface may in certain implementations include a web portal (such as may be provided by Web server 118 of FIG. 1) and/or backend integrations between the MAA system and the lenders' computing systems (such as via API 120). In a manner similar to that described above with respect to the applicant user interface, the lender user interface may also include multiple components in order to provide various aspects of the MAA system, as follows:
Application, which may include electronically submitting the generated mortgage application from the MAA system to multiple lenders' automated underwriting systems (AUS) and loan pricing engines (LP or PE).
Results, which may include receiving the loan decision. If that loan decision includes an approval, Results may also include receiving loan pricing from the lender's AUS and LP or PE.
Communication between the MAA system and the lender's loan origination system (LOS) by which the lender processes the origination and closing of mortgage transactions. In certain implementations, such communication typically includes status information and status requests. Such communication may also include additional requests and information such as loan condition requests and loan condition fulfillment by the borrower (e.g., for situations in which a loan condition is to be satisfied by the borrower).

As indicated above, lender users of the MAA system associated with the lender computing systems 180 may interact with implementations of the MAA system for various reasons, including but not limited to: receiving loan search requests; returning loan search request decisions; receiving electronic mortgage applications; returning lockable loan decisions in real-time; providing or receiving loan status information to/from an applicant user; providing lender access to the applicant, the applicant's consent, the applicant's data, and/or information related to the applicant's participation via the applicant's user interface; and requiring vendors to provide data and services for originating, processing, and closing a loan.

The MAA system may exchange various electronic communications with vendor computing systems 170 associated with vendor users in order to provide various functionality to such users. The vendor's user interface may in certain implementations include a web portal (such as may be provided by Web server 118 of FIG. 1) and/or backend integrations between the MAA system and various vendors' computing systems (such as via API 120). Such vendors may, in certain implementations, include credit report vendors, fraud detection vendors, aggregated financial banking vendors, aggregated asset/liability vendors, identity vendors, property data vendors, MLS vendors and social media vendors. In certain implementations, the generation of the complete mortgage application may include receiving raw data, certification and/or signed PDF document from one or more vendors. In at least some implementations, certain information required for generating the complete mortgage application may include generating such raw data, certification and/or signed PDF documents. In an implementation, in order to receive vendors' products, the MAA system may electronically request an order for various information from the vendor, and may also initiate one or more status requests from the vendors, either before or after the relevant order has been fulfilled.

Vendor users of the MAA system associated with vendor computing systems 170 may interact with implementations of the MAA system for various reasons, including to provide the data and services required from the user and lender in order to originate, process and close a loan. The MAA system may facilitate communications between the vendor and the applicant user who desires to apply for and receive mortgage loan, and a lender who desires to order data and services provided by vendors.

Thus, as seen above, the MAA system may automatically create a complete mortgage application by aggregating data from multiple vendor sources, thereby creating a completely electronic, automated and hands-free mortgage application with supporting data verification and certification directly from third-party vendors. The process by which a mortgage application is generated includes gathering data for the mortgage application from credible sources directly, and therefore may reduce the time and effort required for a user to complete a mortgage application. Furthermore, the data integrity of the generated mortgage application may be improved due to the data not being given and later verified, but due to the data coming from the source of verification directly and in an automated manner.

### Exemplary Controller Computing System

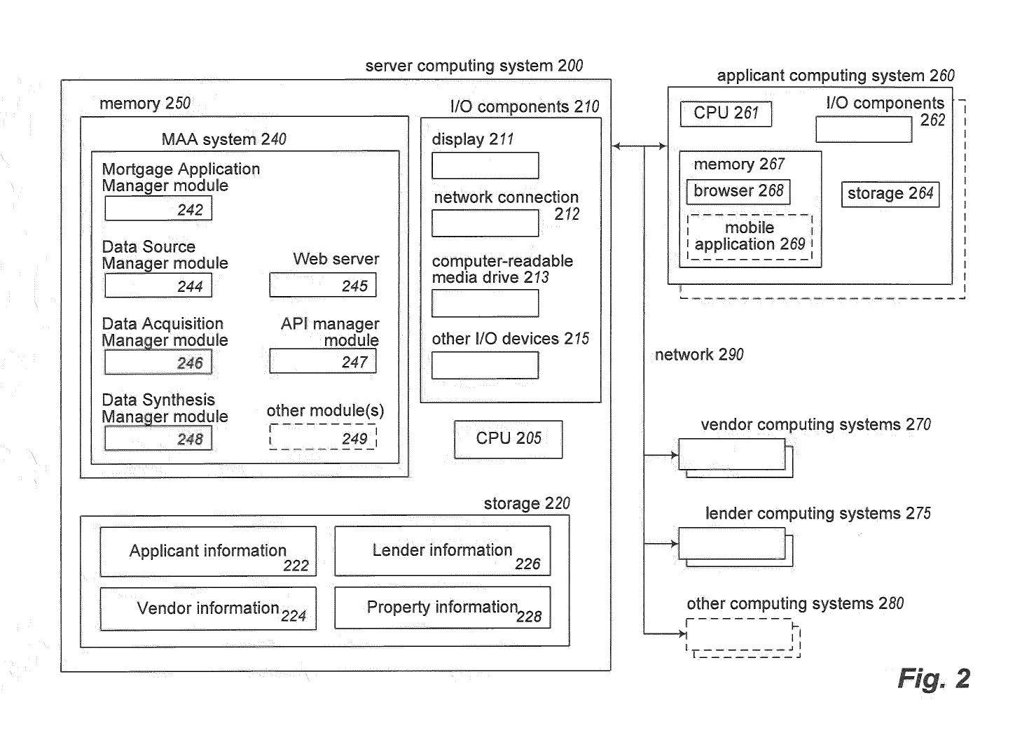

FIG. 2 illustrates a block diagram illustrating component-level functionality provided by a plurality of electronic circuits that, when in combined operation, are suitable for performing and configured to perform at least some of the techniques described herein. In the particular implementation depicted, the plurality of electronic circuits is at least partially housed within a server computing system 200 executing an implementation of an MAA system that performs at least some of the described techniques. The server computing system is communicatively coupled to an applicant computing system 260, vendor computing systems 270, lender computing systems 275, and optionally, other computing systems 280.

In the illustrated implementation, the server computing system 200 includes a CPU 205, various I/O devices 210, storage 220, and memory 250. The I/O devices include a display 211, a network connection 212, a computer-readable media drive 213, and other I/O devices 215. An implementation of a Mortgage Application Automation system 240 is executing in memory, and includes a mortgage application manager module 242; a data source manager module 244; a data acquisition manager module 246; a data synthesis manager module 248; a Web server 245; an API manager module 247; and optionally, other system modules 249.

The MAA system 240 interacts with the applicant computing system 260 and the other computing systems 270, 275, and 280 over the network 290 using the network connection 212 (e.g., via the Internet and/or the World Wide Web, cell network, telephone network, etc.). In particular, an applicant user of the computing system 260 may interact with the server computing system 200 in order to perform various interactions with the MAA system 240, such as by using browser 268 or mobile application program 269 executed by CPU 261 and in memory 267.

The MAA system 240 and its modules may also access and use various non-transitory information on storage 220 or elsewhere, such as information stored in one or more of applicant information database 222, vendor information database 224, lender information database 226, and property information database 228. In addition, in some implementations the MAA system may also interact with other optional modules 249 executing in memory 250 and/or other optional computing systems 280 to perform additional related functionality.

Those skilled in the art will appreciate that computing systems 200, 260, 270, 275, and 280 are merely illustrative and are not intended to limit the scope of the present disclosure. The MAA system may instead be executed by multiple interacting computing systems or devices, and computing system 200 may be connected to other devices that are not illustrated, including through one or more networks such as the Internet, via the World Wide Web (“Web”), or other electronic communications network (e.g., cellular based network, public switched telephone network). More generally, a “client” or “server” computing system or device may comprise any combination of hardware or software that can interact, including (without limitation) desktop or other computers, network devices, PDAs, cell phones, smart phones, tablet computing systems, wireless phones, pagers, electronic organizers, Internet appliances, television-based systems (e.g., using set-top boxes and/or personal/digital video recorders), game consoles, media players and various other consumer products that include appropriate inter-communication capabilities. In addition, the functionality provided by the discussed MAA system modules may in some implementations be combined in fewer modules or distributed in additional modules. Similarly, in some implementations, the functionality of some of the modules may not be provided as part of the MAA system and/or other additional functionality may be available.

In at least some implementations, one or more of the illustrated modules and/or systems may be software-based modules/systems including software instructions that, when executed by the CPU(s) 205 or other processor(s), program the processor(s) to automatically perform the described operations for that module/system. Furthermore, in some implementations, some or all of the systems and/or modules may be implemented or provided in other manners, such as at least partially or wholly in designed and configured firmware and/or hardware means, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions contents or structured data contents) on a non-transitory computer-readable storage medium, such as a hard disk or flash drive or other non-volatile storage device, volatile or non-volatile memory (e.g., RAM), a network storage device, or a portable media article (e.g., a DVD disk, a CD disk, an optical disk, a flash memory device, etc.) to be read by an appropriate drive or via an appropriate connection. Those skilled in the art will also appreciate that, while various items are discussed or illustrated as being stored in memory or on storage while being used, these items or portions of them can be transferred between memory and other storage devices for purposes of memory management and data integrity. Alternatively, in other implementations some or all of the software modules and/or components may execute in memory on another device and communicate with the illustrated computing system via inter-computer communication. Such computer program products may also take other forms in other implementations. Accordingly, the present invention may be practiced with other computer system configurations.

### Graphical User Interface

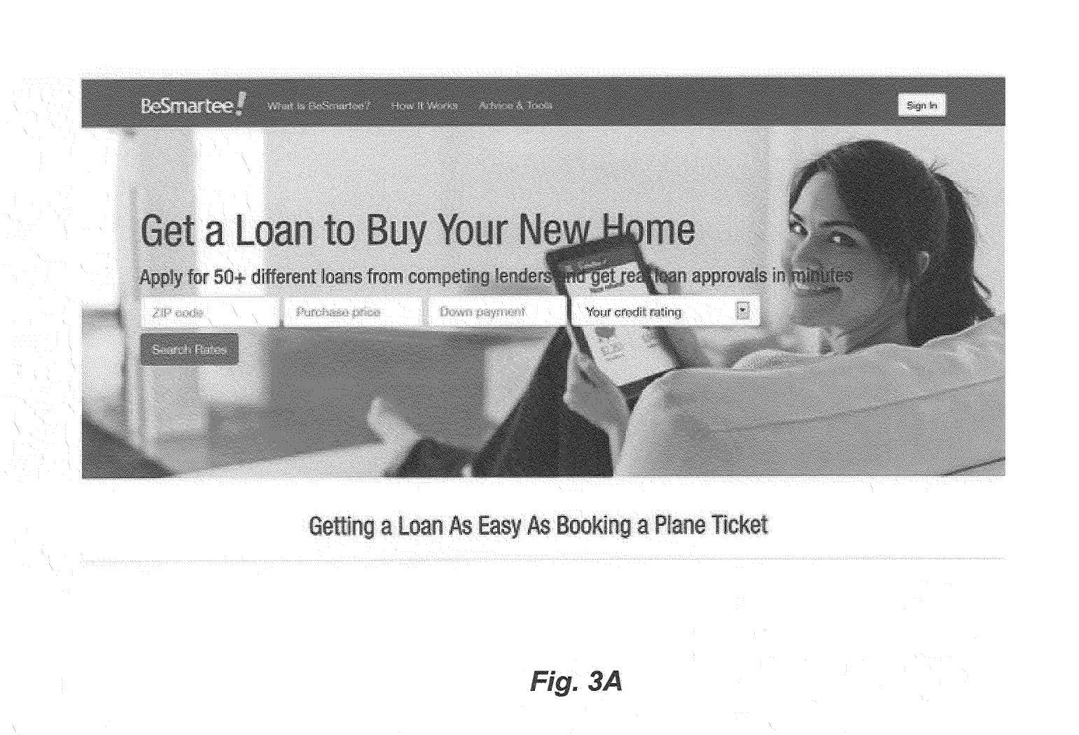

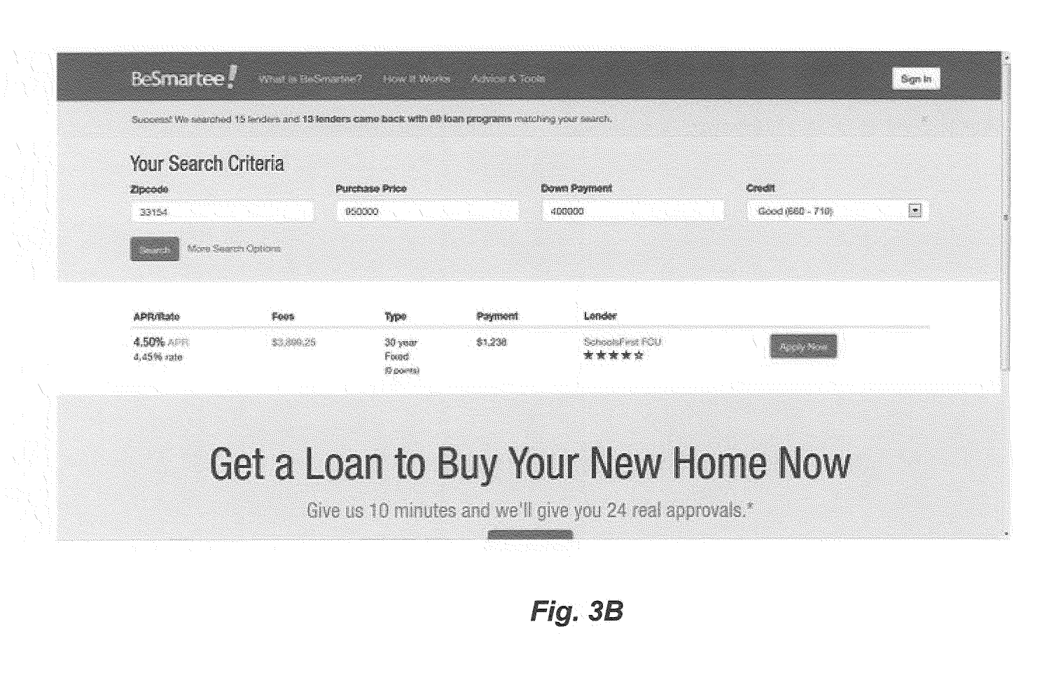

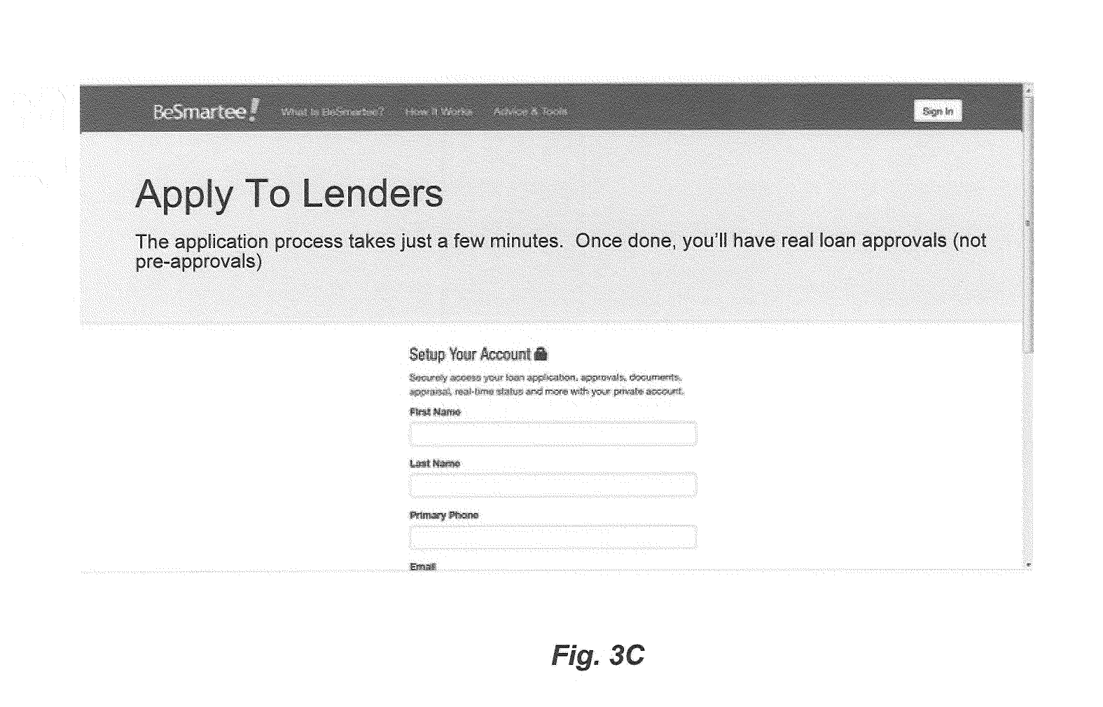

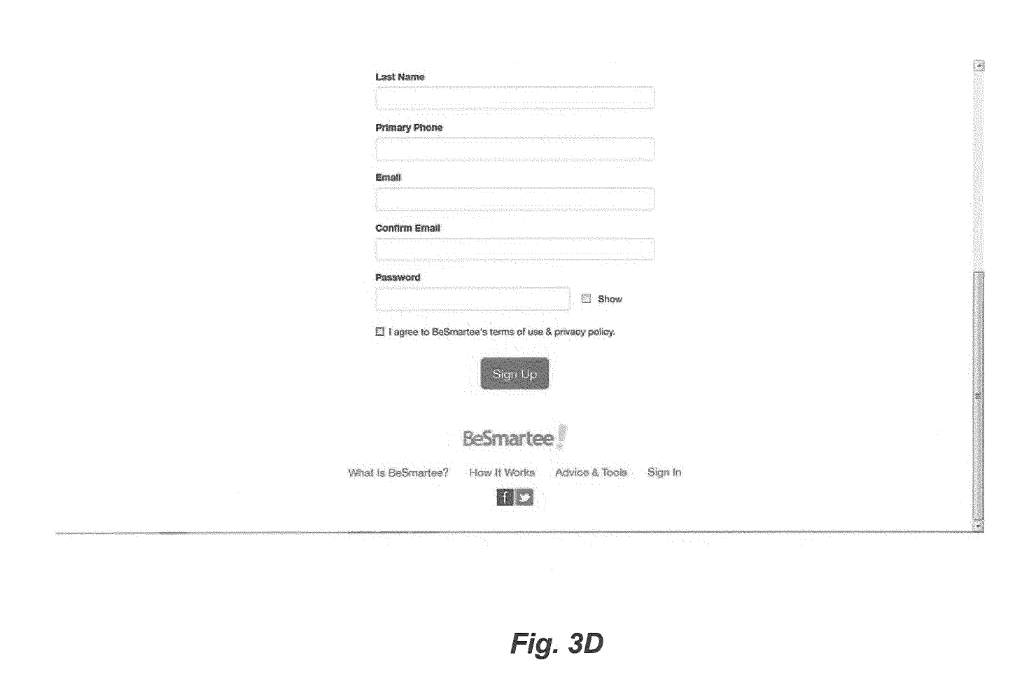

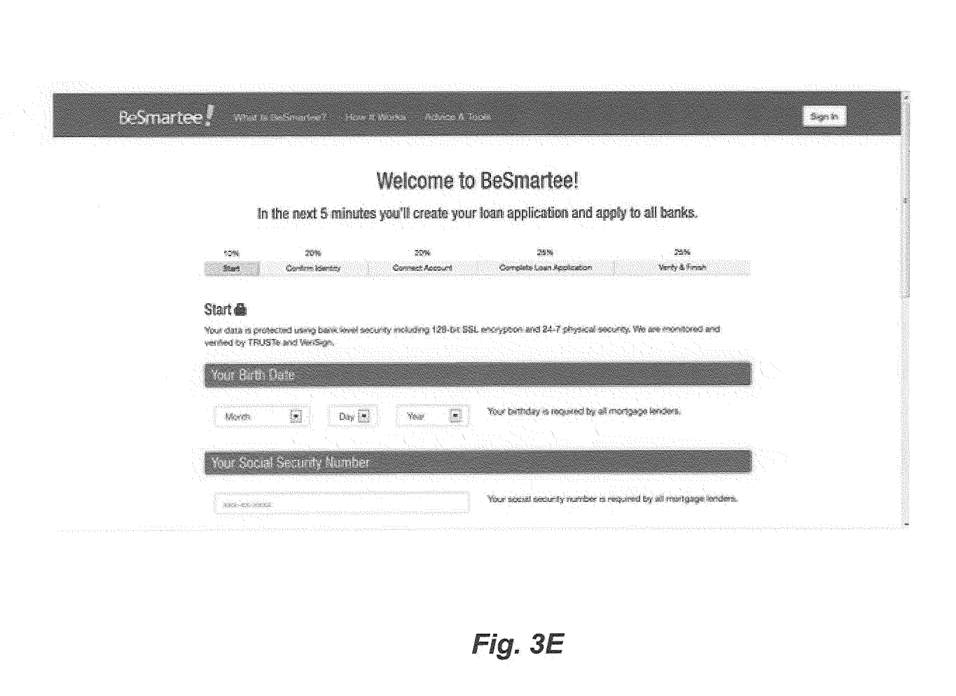

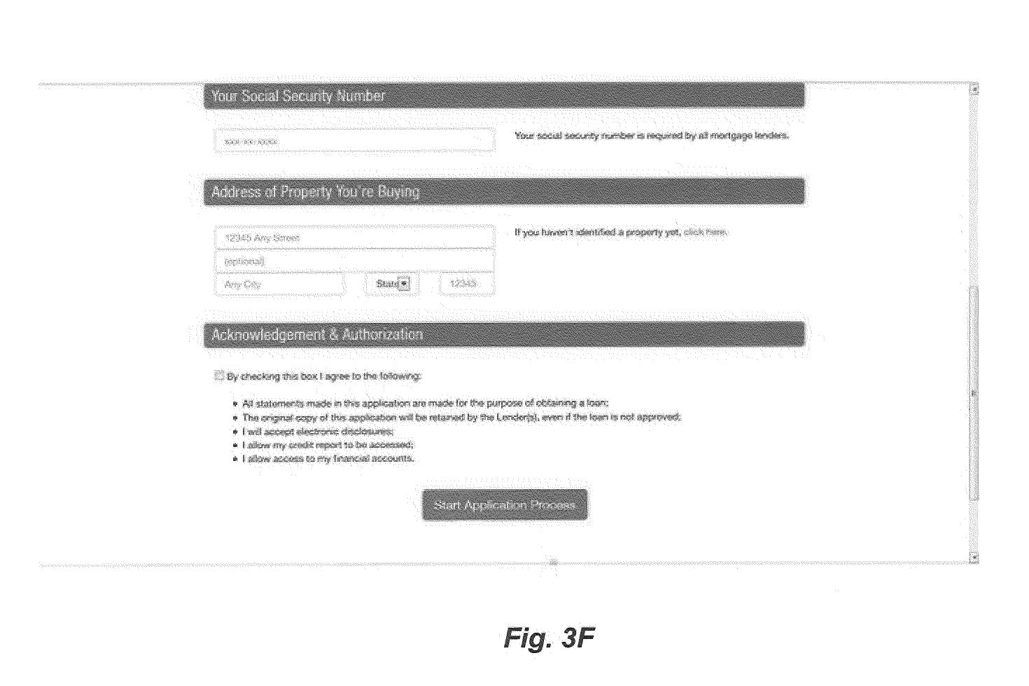

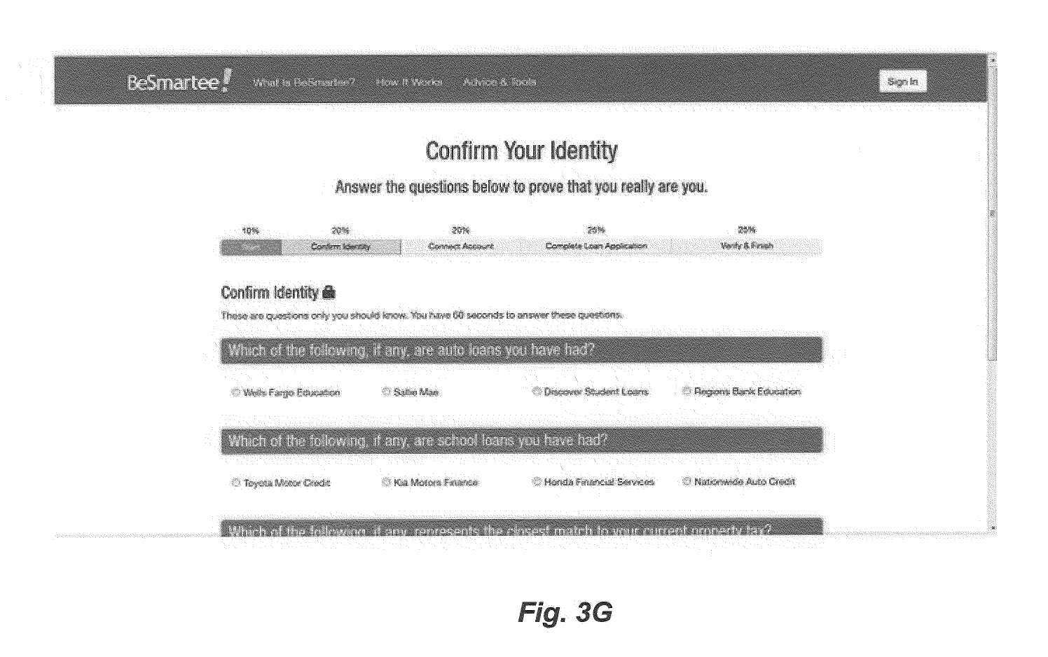

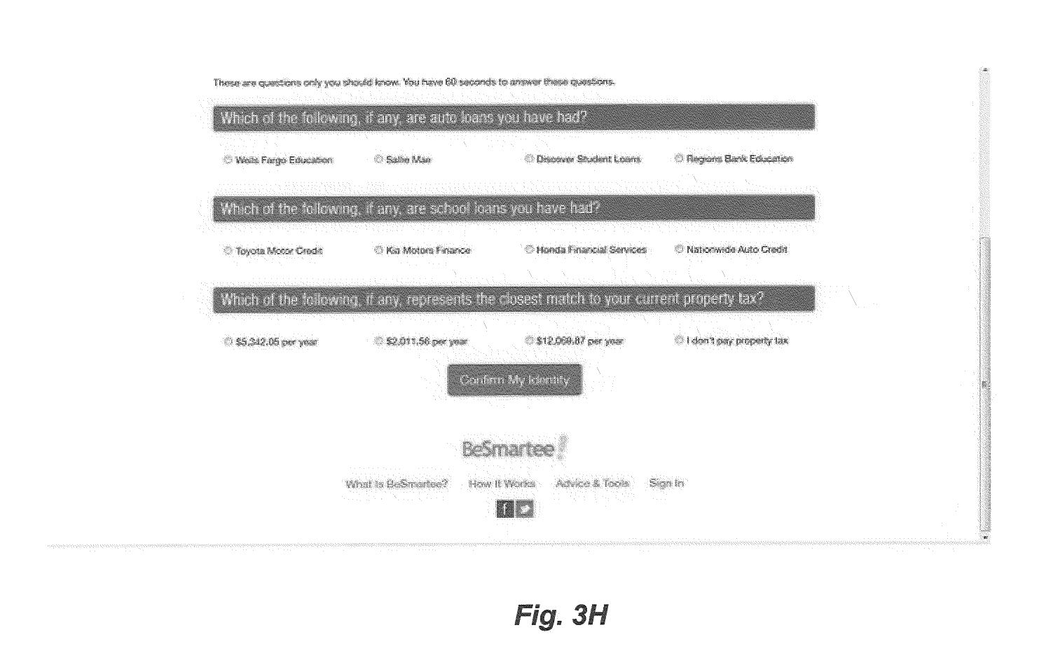

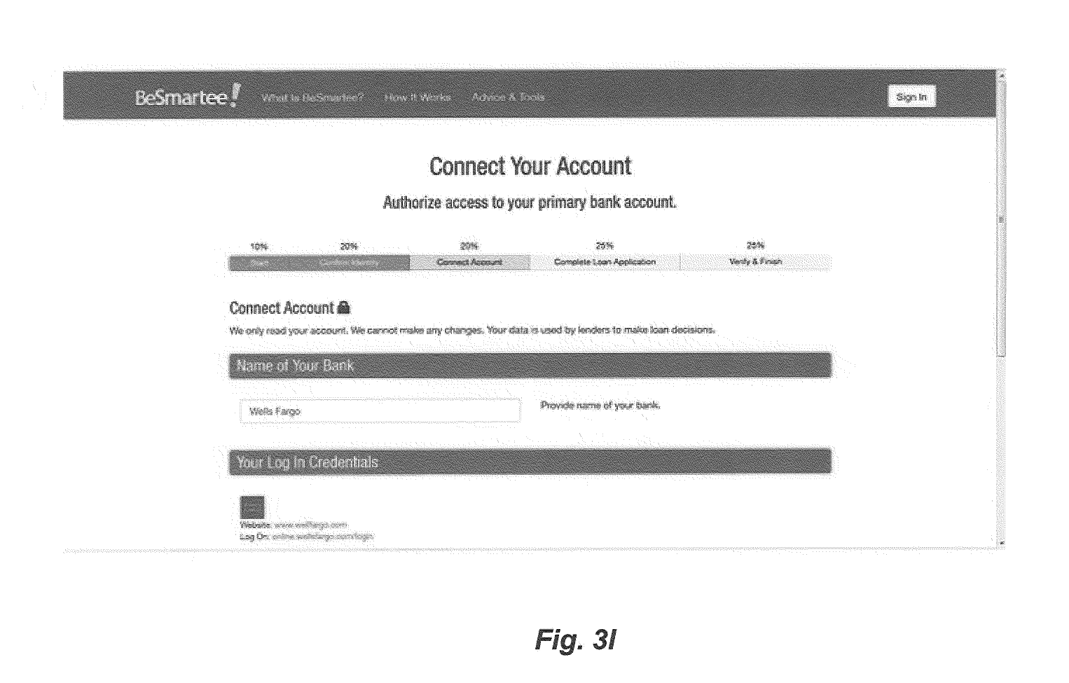

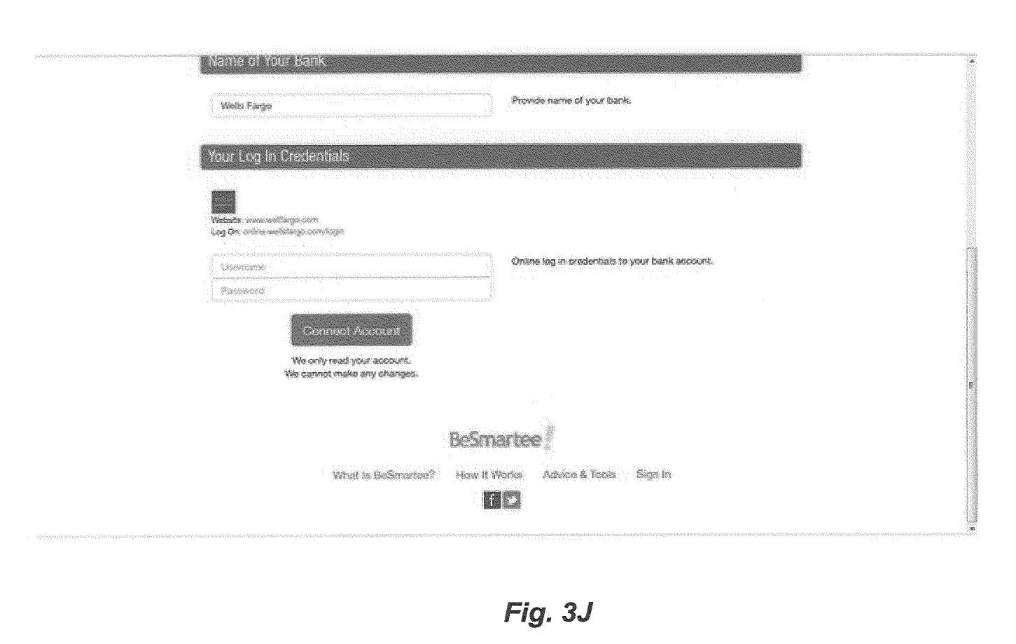

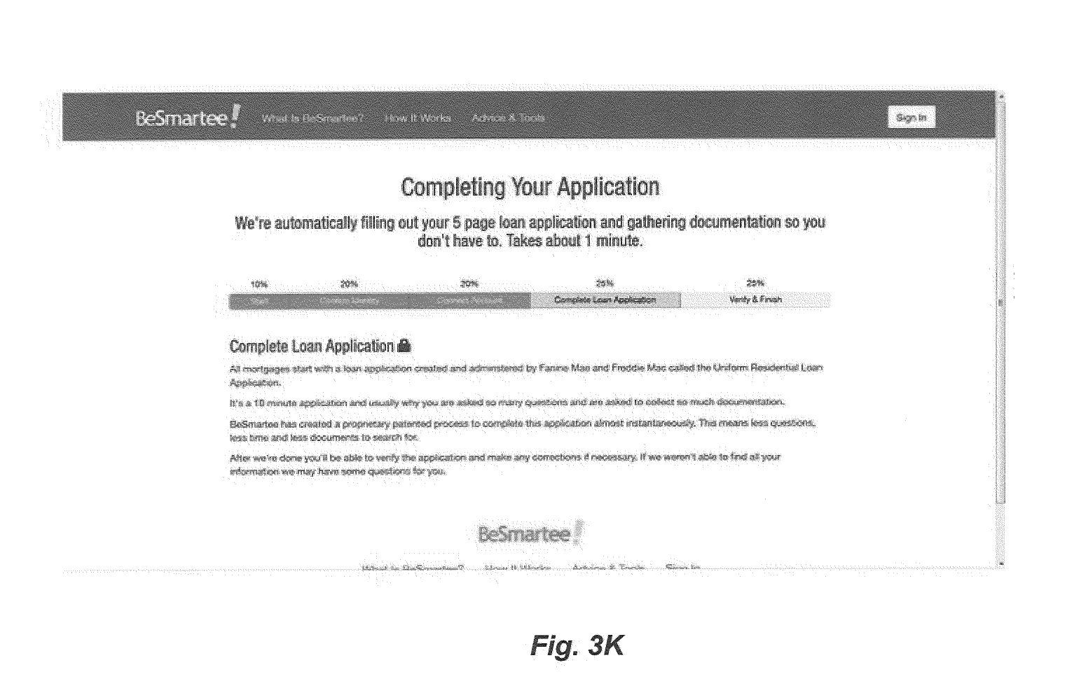

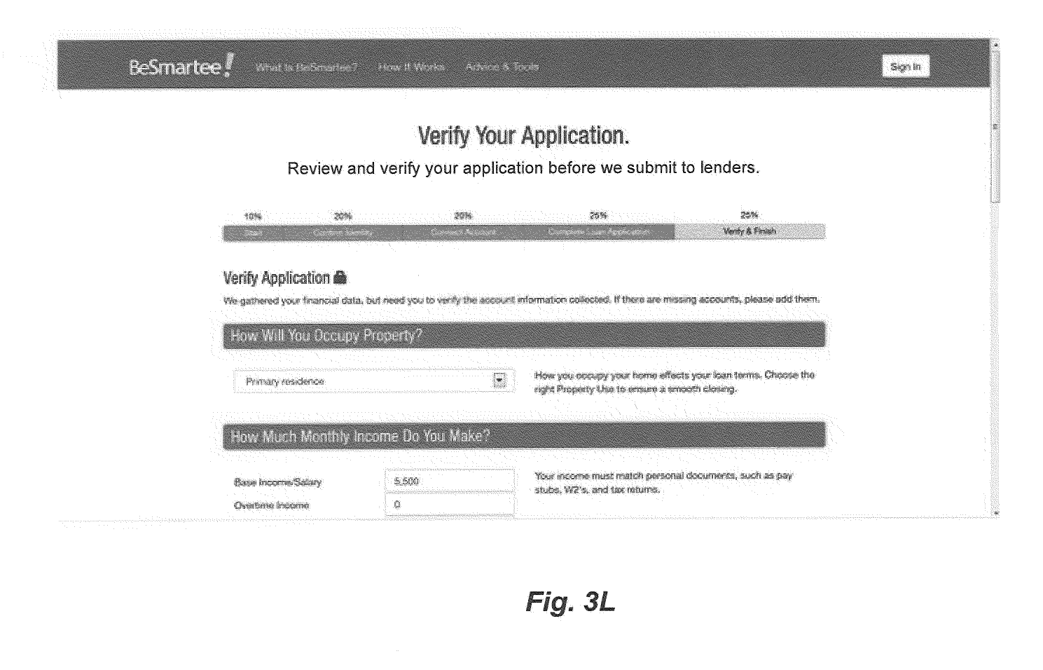

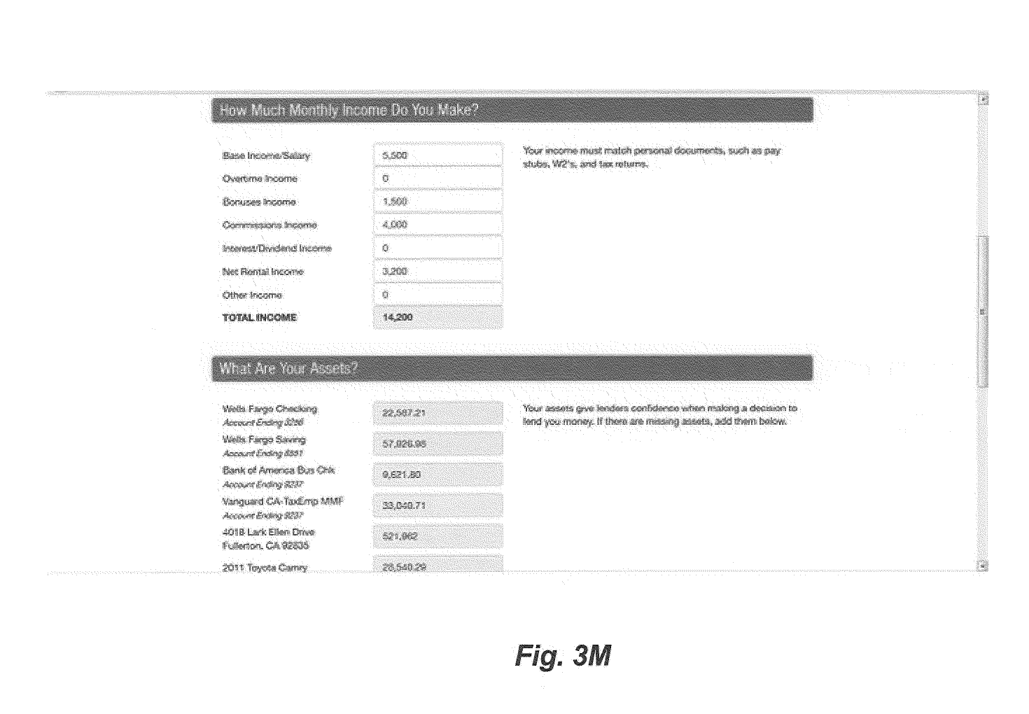

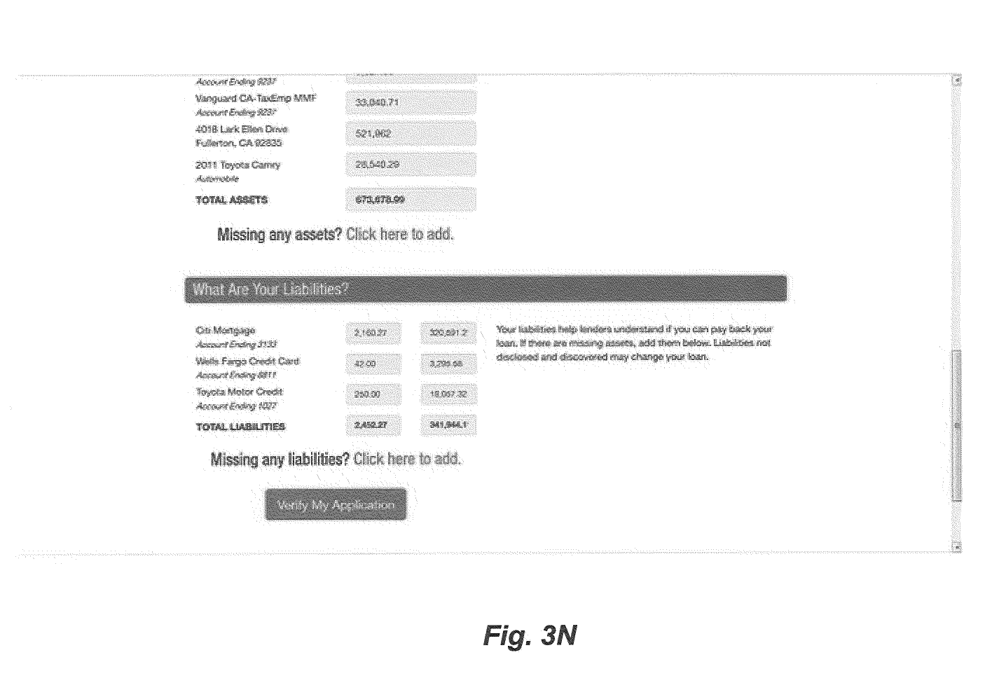

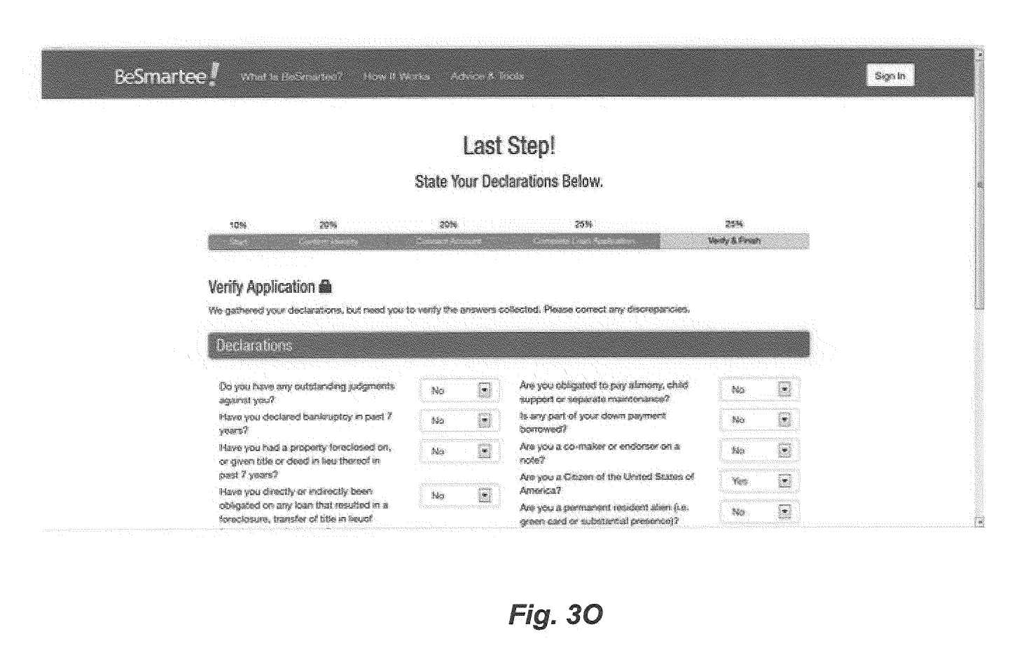

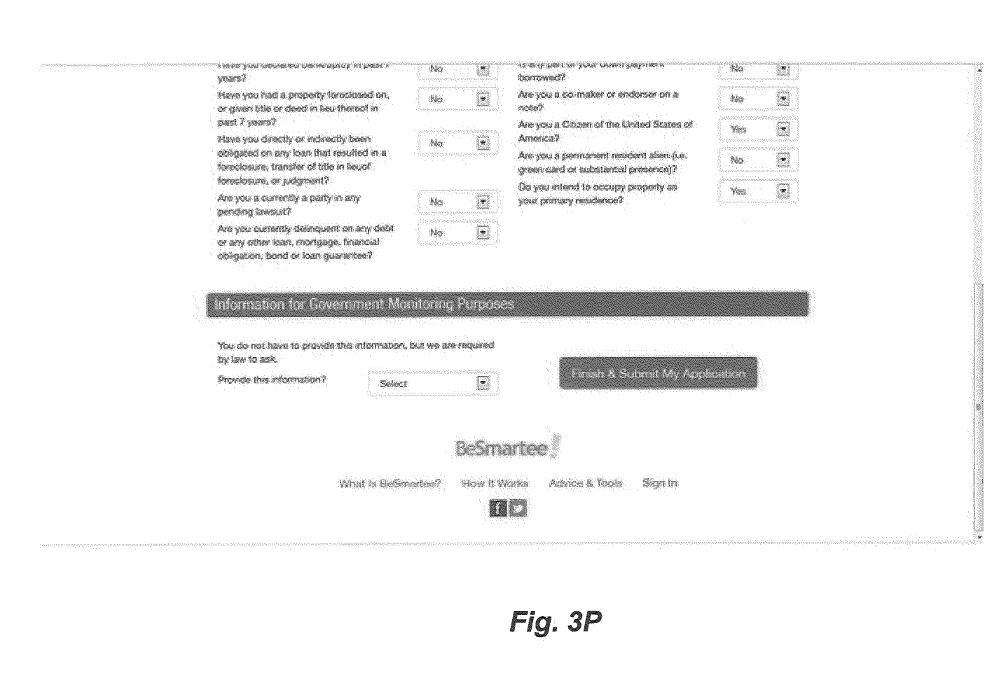

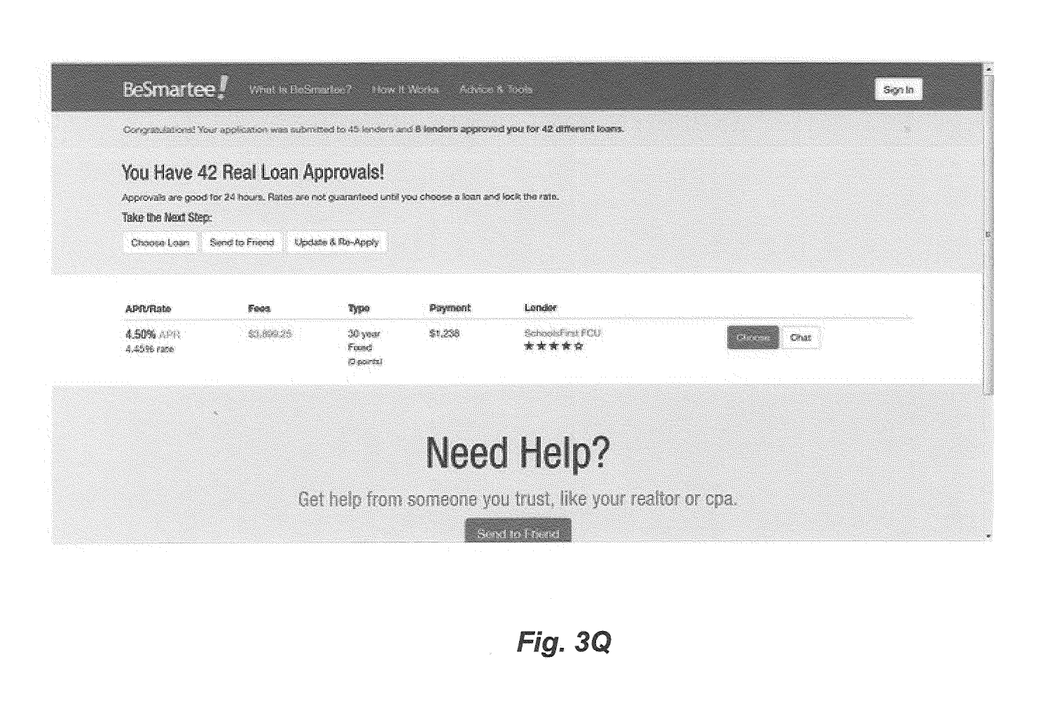

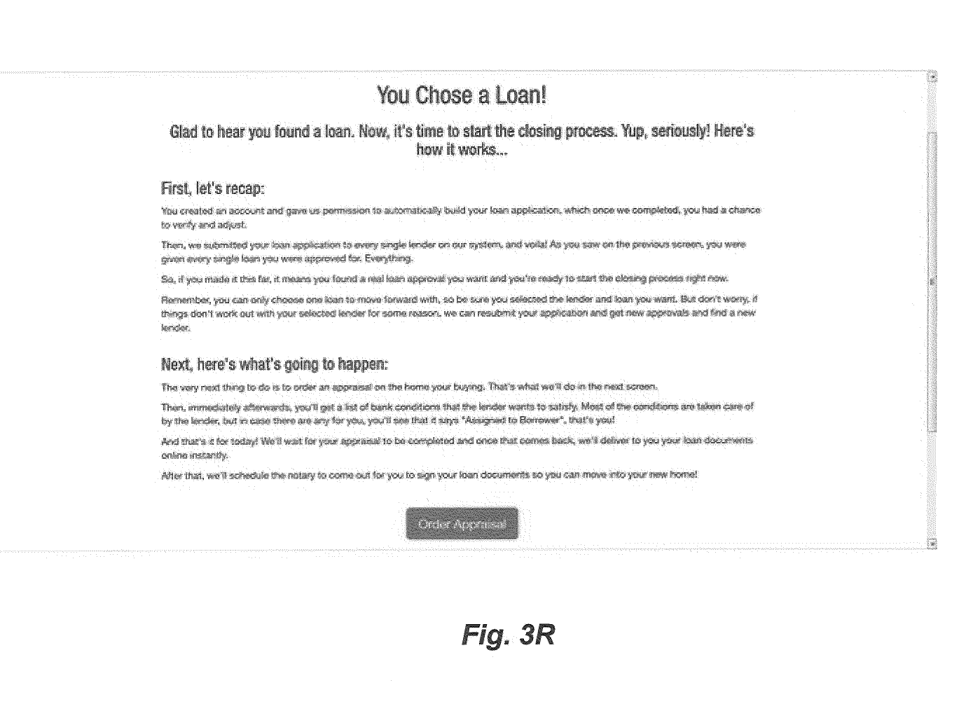

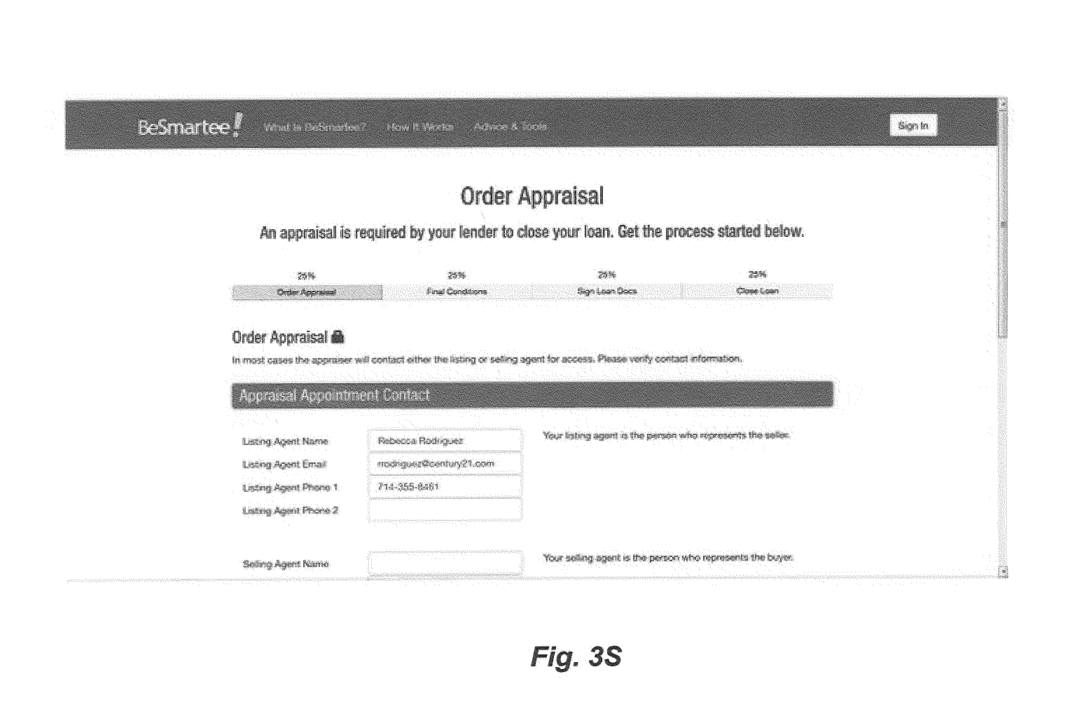

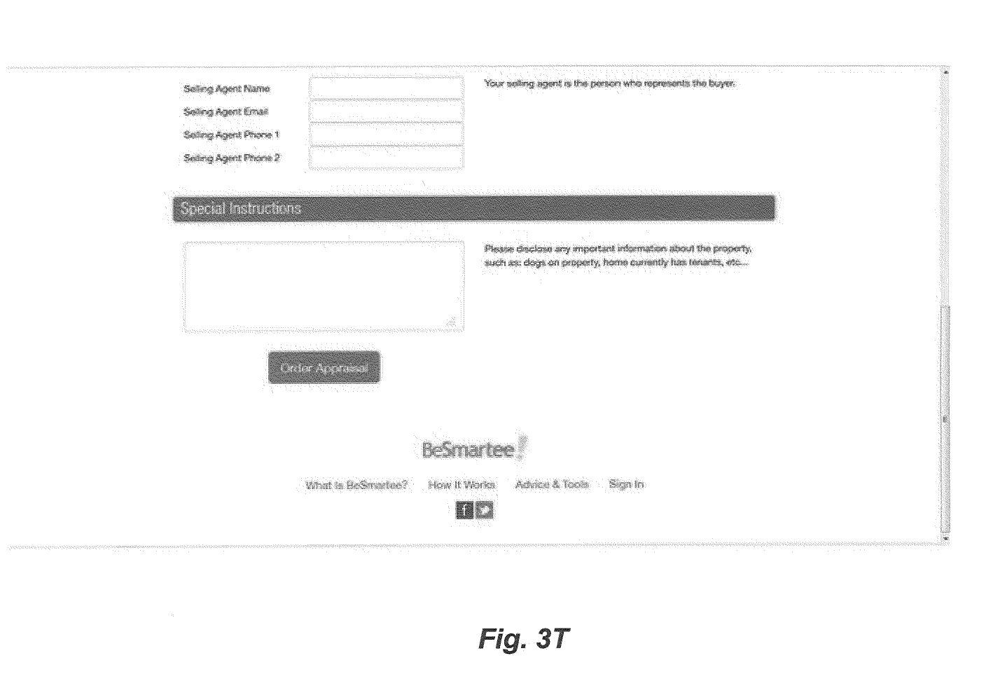

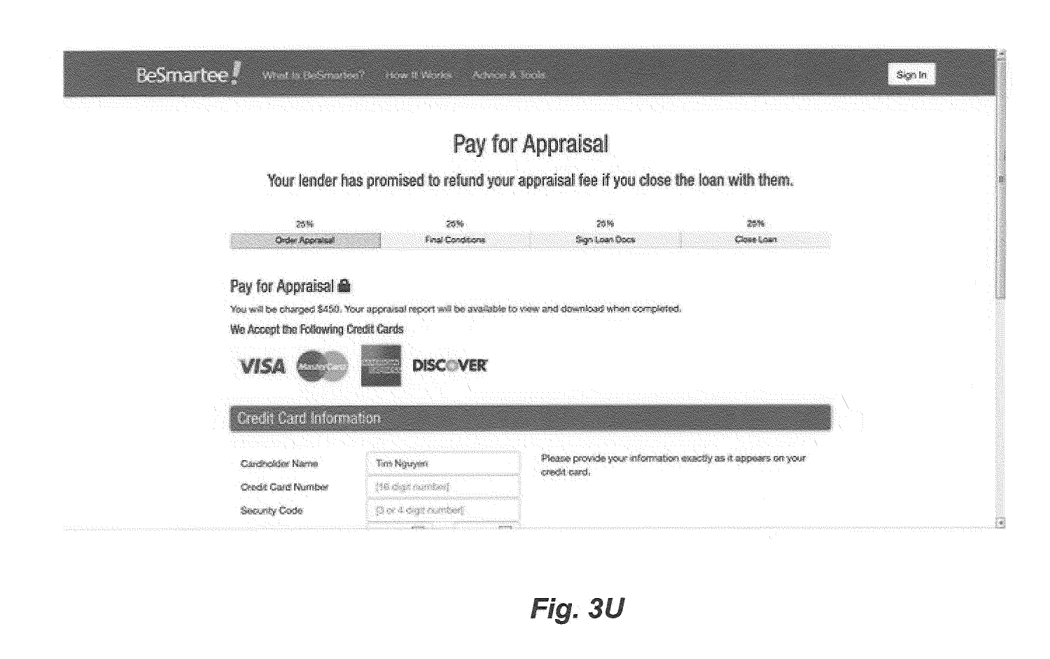

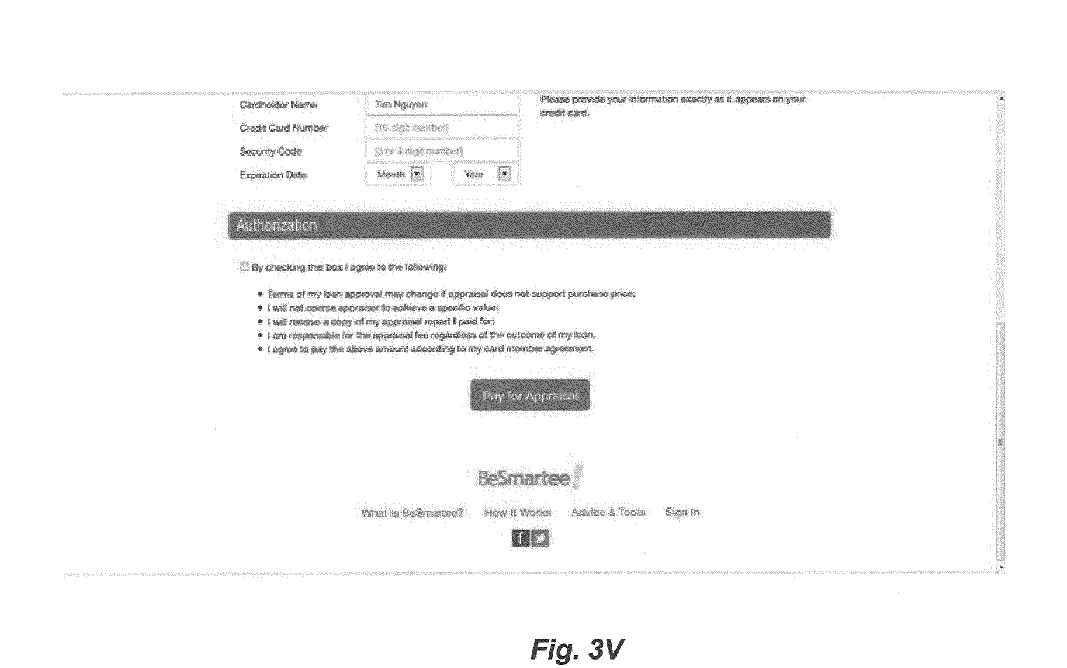

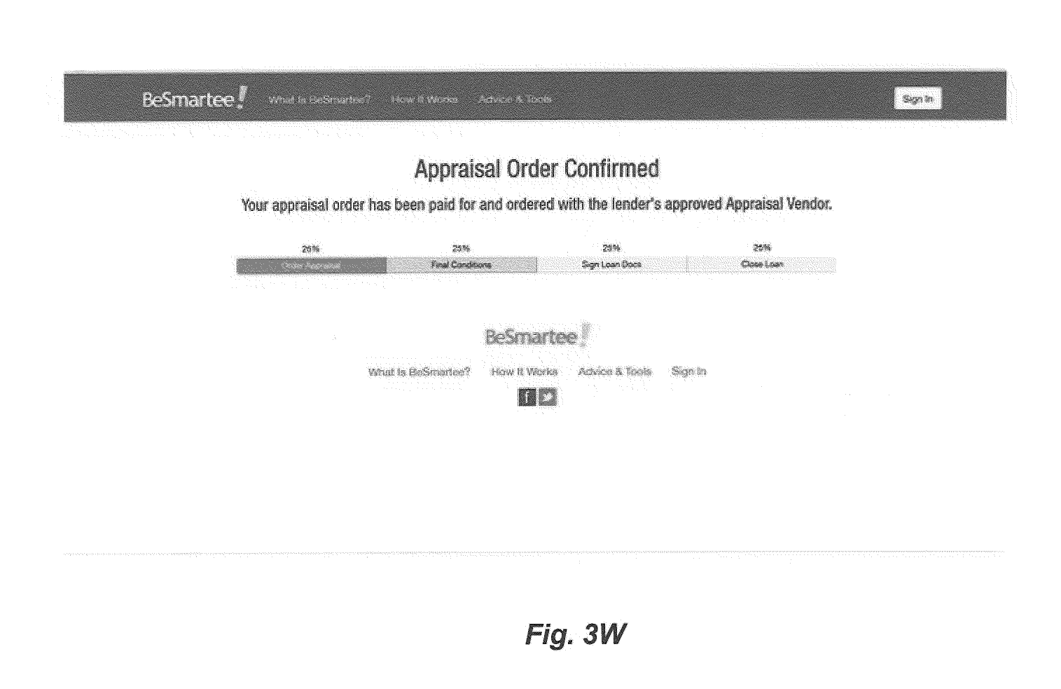

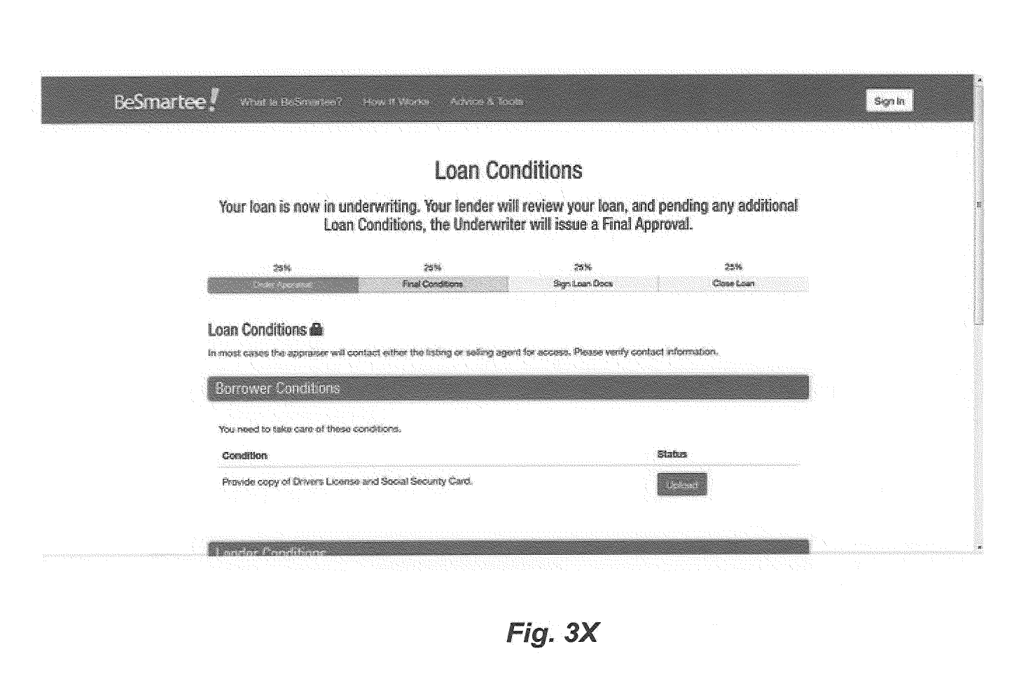

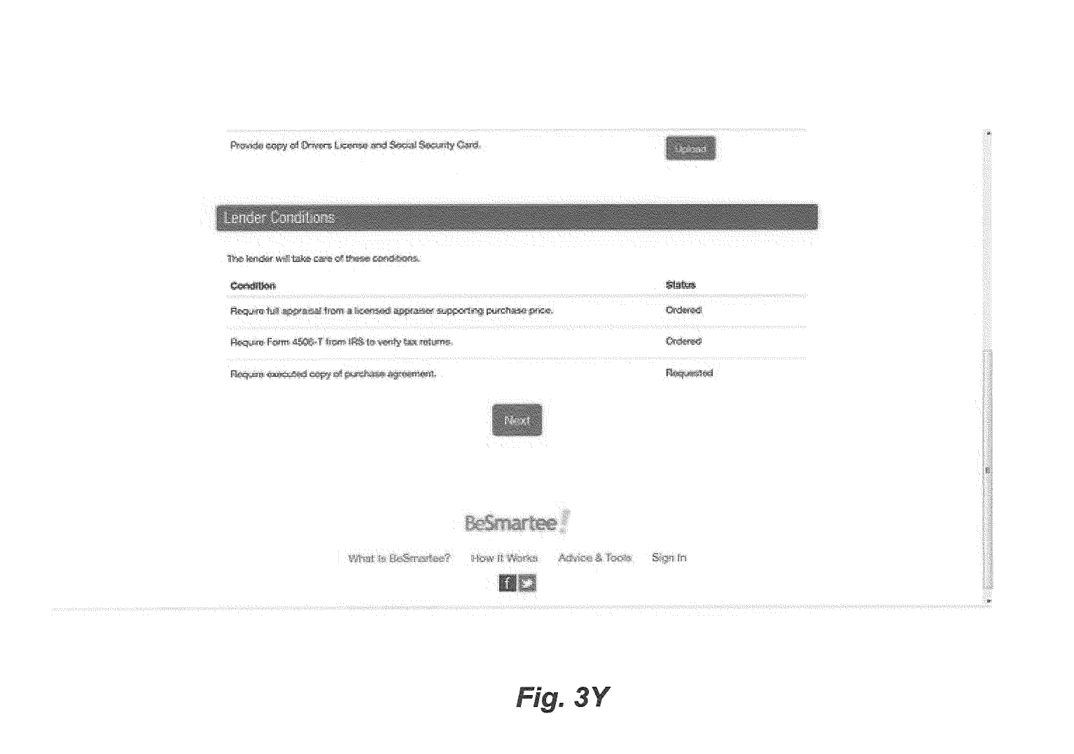

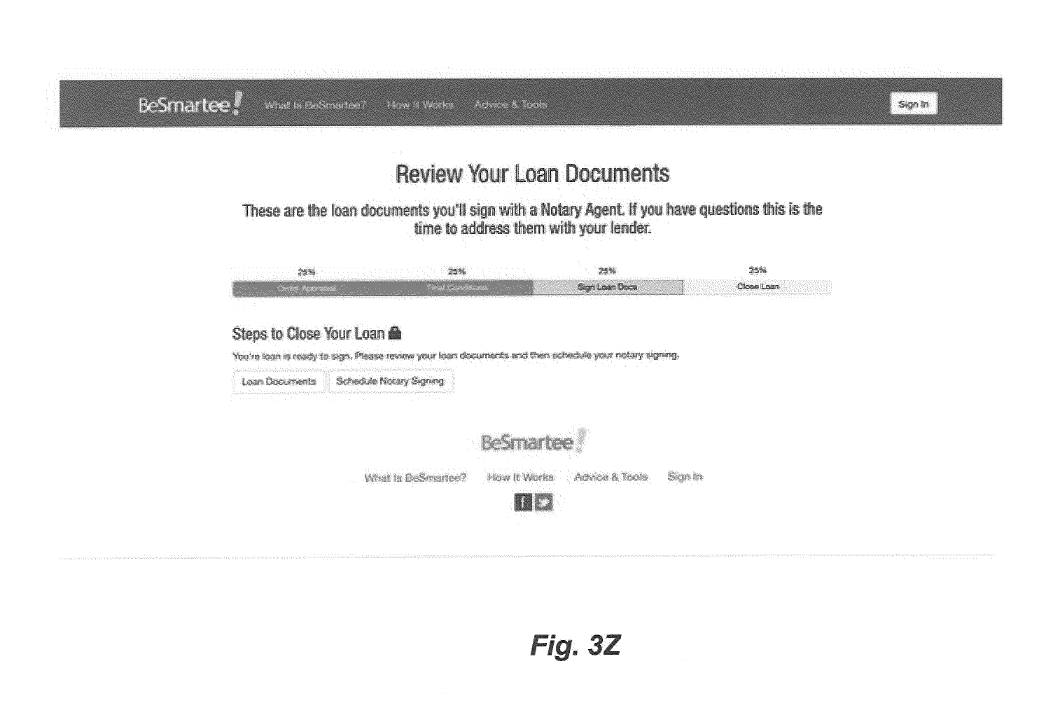

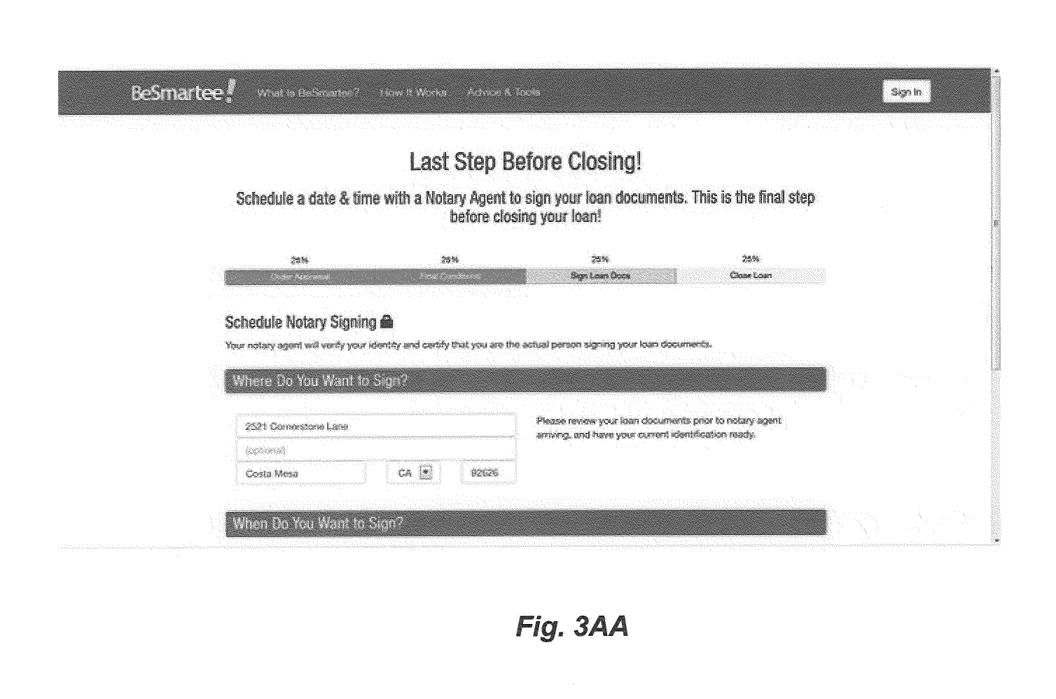

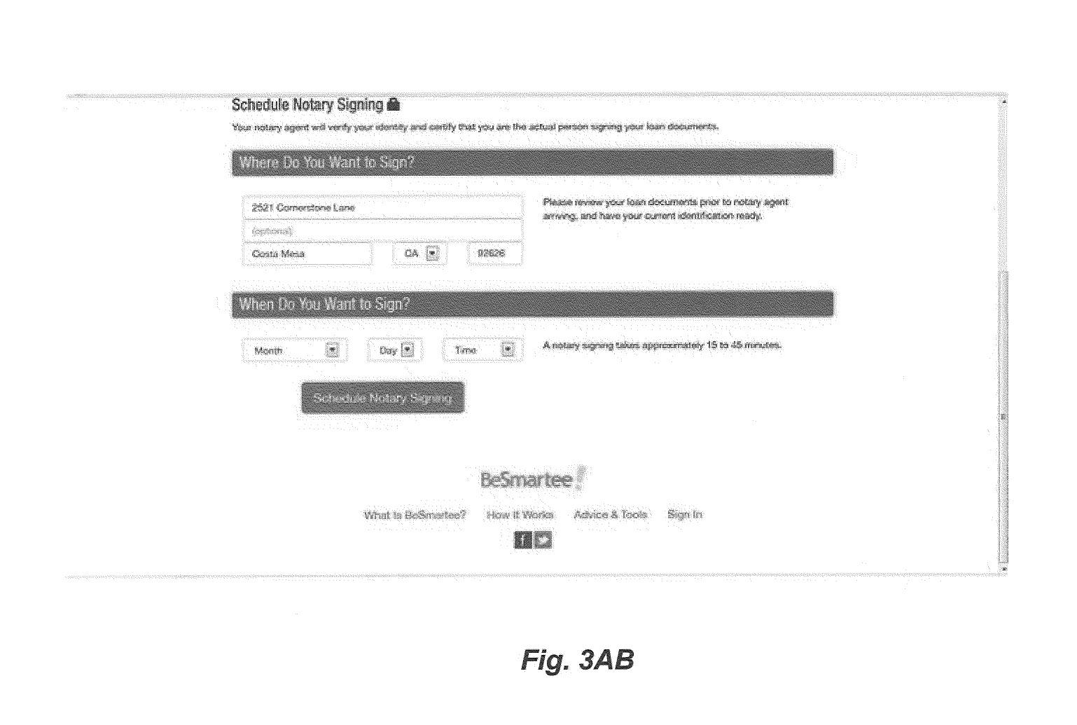

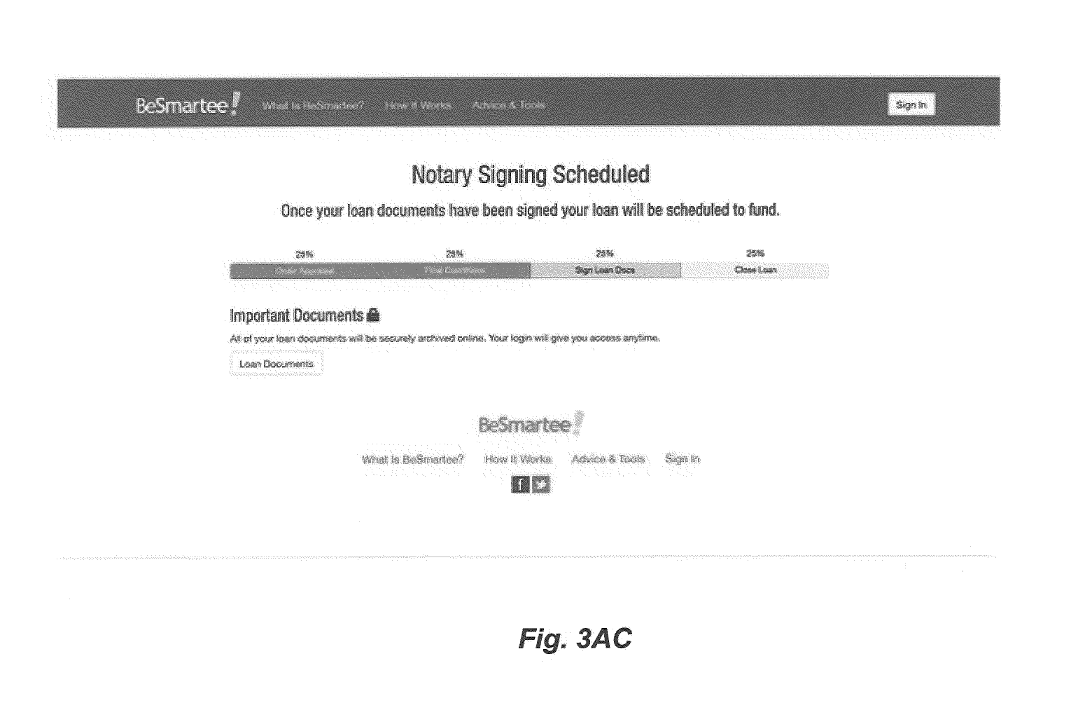

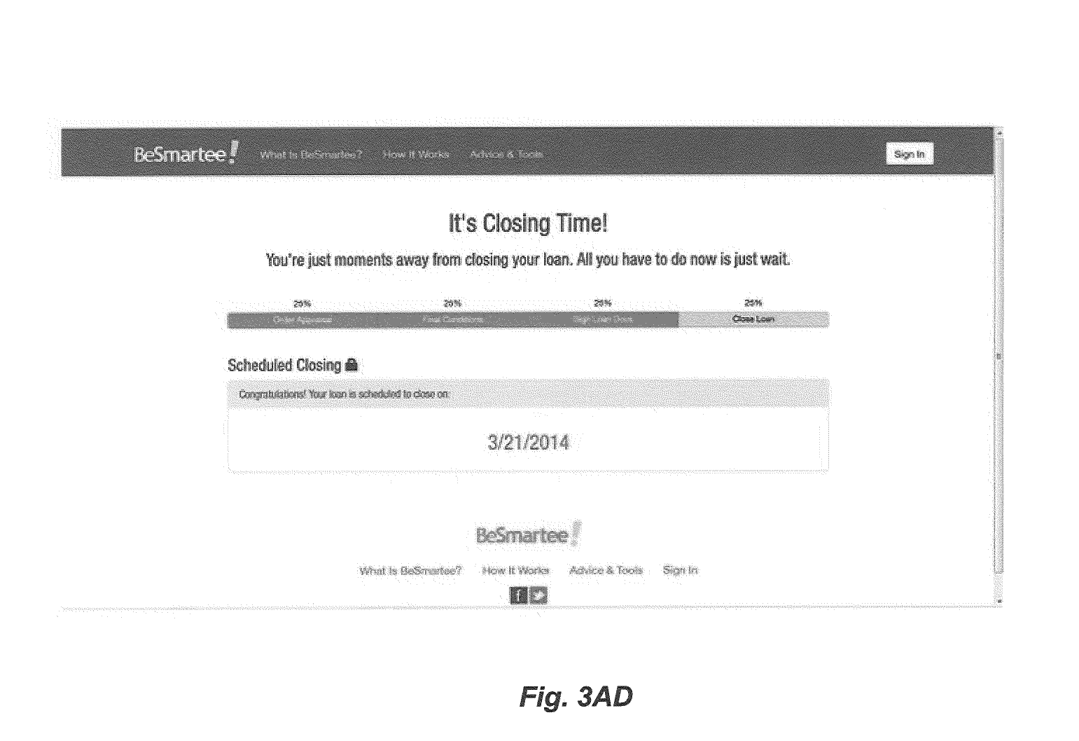

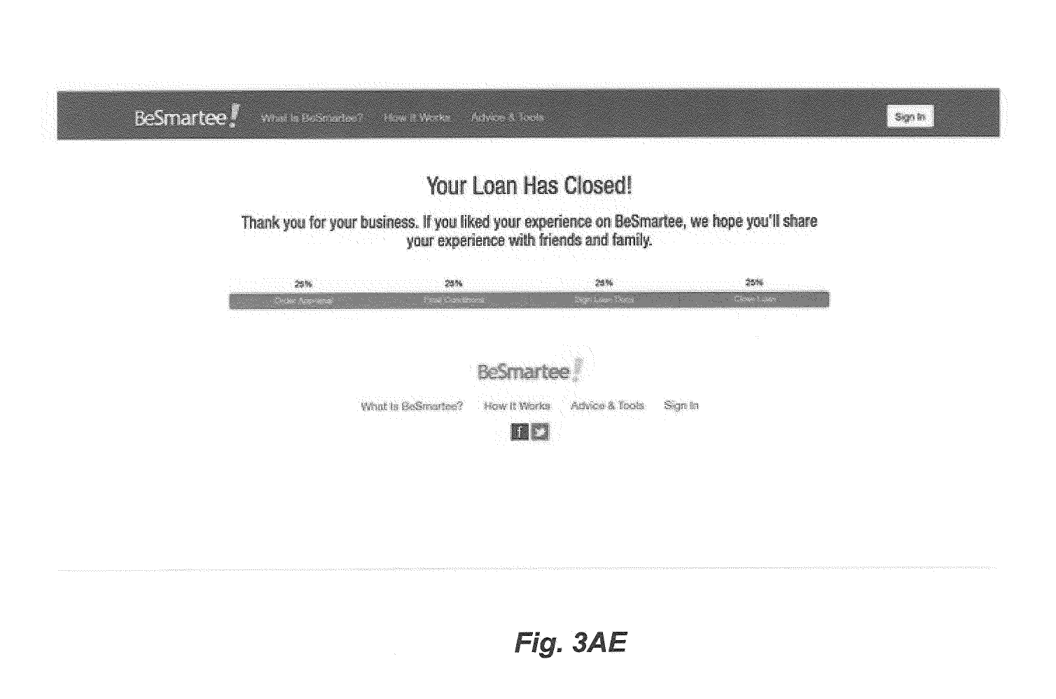

Various example graphical user interface (“GUI”) screens for the MAA system will now be presented with respect to particular implementations shown for illustrative purposes, although it will be appreciated that other implementations may include more and/or less information, and that various types of illustrated information may be replaced with other information. In particular, FIGS. 3A-3AE depict certain portions of a GUI that may be provided to enable various applicant interactions with an MAA system, according to one illustrated implementation.

FIG. 3A illustrates a GUI of a main entry page that allows a user to access and interact with an example implementation of the Mortgage Application Automation (“MAA”) system that is providing a MAA Web site—in this example, the main entry page is one of multiple Web pages of the MAA Web site, and allows an applicant user to “sign in” to an existing user account or search for information related to available mortgage loans.

FIG. 3B illustrates a GUI of a data entry page that allows an applicant user to view search results for search criteria previously entered by the user and provide additional and/or modified criteria for performing and other search for information related to available mortgage loans.

FIGS. 3C-3D illustrate a GUI of an account creation page that allows an applicant user to create an account for use with an implementation of the MAA system.

FIGS. 3E-3F illustrate a GUI of a data entry page that allows an applicant user to provide basic identifying information regarding the applicant and the parcel of real property that the applicant wishes to purchase.

FIGS. 3G-3H illustrate a GUI of an identity confirmation page that allows an applicant user to provide information requested by the MAA system to verify the applicant's identity.

FIGS. 3I-3J illustrate a GUI of financial account authorization page that allows an applicant user to provide information needed to confirm details regarding the applicant's financial accounts for use with the MAA system. In various implementations, one or more similar interfaces may be provided to an applicant user to allow the user to provide access to one or more social media or other accounts associated with the user. In addition, in certain implementations the applicant user may be provided with various interfaces to confirm employment history information accessed or synthesized by the MAA system.

FIG. 3K illustrates a GUI of a process summary page that provides an applicant user with status information while the MAA system generates the user's mortgage application.

FIGS. 3L-3N illustrate a GUI of an application verification page that allows an applicant user to review and verify particular information used to generate the user's mortgage application.

FIGS. 3O-3P illustrate a GUI of a declaration page that allows an applicant user to validate information or declarations contained in the user's mortgage application.

FIG. 3Q illustrates a GUI of an approval results page that provides an applicant user with information related to loan approvals received based on the generated mortgage application for the user. In various implementations, the user may be provided with a plurality of selectable controls that are each respectively associated with a different potential lender, such that the user may individually select one or more particular lenders to which the mortgage application generated by the MAA system may be submitted. In other implementations, the MAA system may enable the user to designate in one or more other manners particular lenders to which the generated mortgage application is to be submitted.

FIG. 3R illustrates a GUI of a process summary page that provides information to an applicant user regarding previous and future portions of the automated mortgage application process in accordance with an implementation of the MAA system.

FIGS. 3S-3T illustrate a GUI of an appraisal order page that allows an applicant user to initiate and order a real property appraisal related to the user's selected loan package.

FIGS. 3U-3V illustrate a GUI of an appraisal payment page that allows an applicant user to provide payment information related to a real property appraisal.

FIG. 3W illustrates a GUI of an appraisal confirmation page that provides an applicant user with information confirming a real property appraisal ordered using the MAA system.

FIGS. 3X-3Y illustrate a GUI of a loan condition summary page that enables an applicant user to provide additional information required by the lender associated with the user's selected mortgage loan package.

FIG. 3Z illustrates a GUI of a loan document review page that allows an applicant user to review various documentation related to the user's selected mortgage loan package.

FIGS. 3AA-3AB illustrate a GUI of a notary agent scheduling page that allows an applicant user to schedule a physical notary signing related to the purchase of the user's parcel of real property.

FIG. 3AC illustrates a GUI of a notary signing confirmation page that provides confirmation details related to the user's scheduled notary signing.

FIG. 3AD illustrates a GUI of a notification page that provides information related to a closing schedule for the user's purchase of a parcel of real property.

FIG. 3AE illustrates a GUI of a notification page presented by an implementation of the MAA system, informing the applicant user that their loan package has been fully executed.

It will be appreciated that the details of the GUI interfaces are provided for illustrative purposes only, and that in other implementations additional graphical components or user-selectable controls may be provided in other manners, such as in other locations of a Web page, with or without overlapping and/or overlaying other portions of the graphical user interface, in one or more separate frames or other display portion of the Web page, in a separate pop-up window or other separate display area that is associated with but not part of the Web page, being initiated or controlled in various manners (e.g., via JavaScript, HTLM5, cascading style sheets, Adobe Flash, Ajax, Dynamic HTML, by dynamically modifying the content of the Web page, etc.), etc. In addition, it will be appreciated that various user-selectable controls may be provided to enable additional interactions with a monitored mobile device via the CIC and/or MDCI. Similarly, the particular types of user-selectable controls that are displayed are simplified for the sake of understanding, and other types of controls may be displayed in other implementations.

Specific Example of Operation—Acquisition and Synthesis of Mortgage Application Based on Limited Information from Applicant

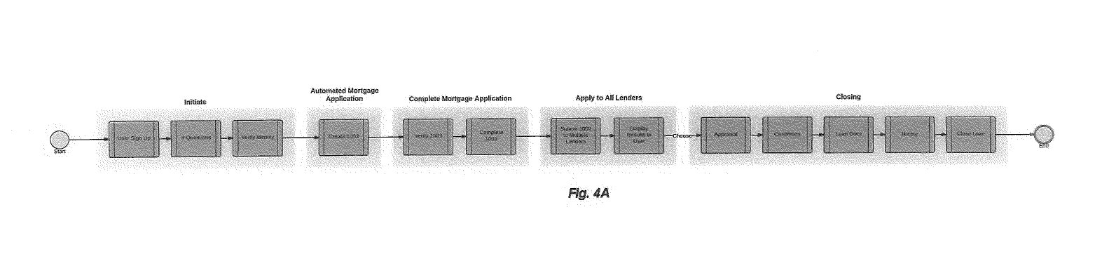

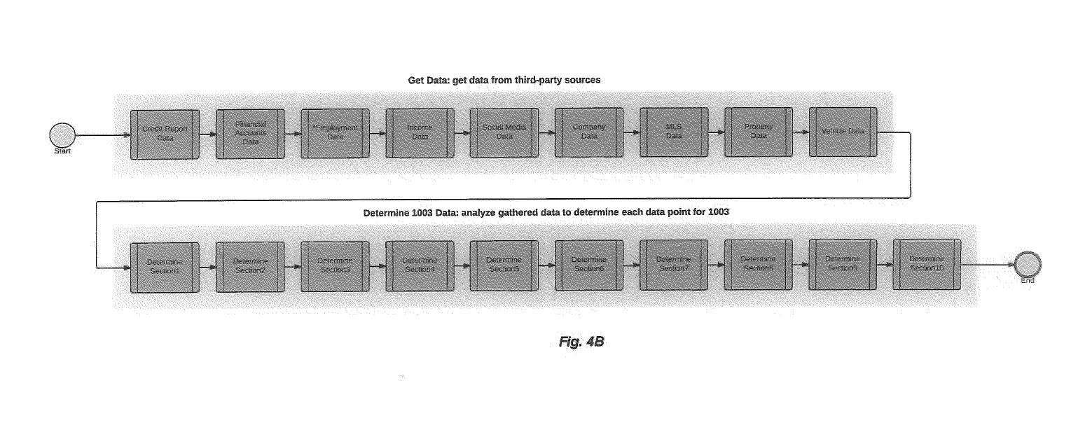

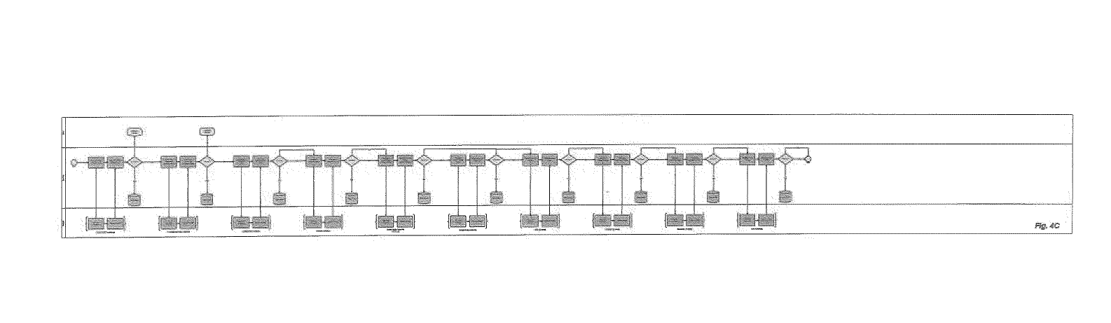

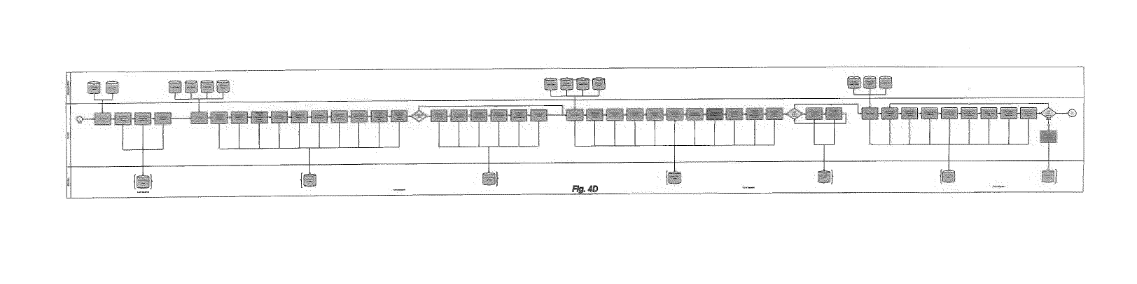

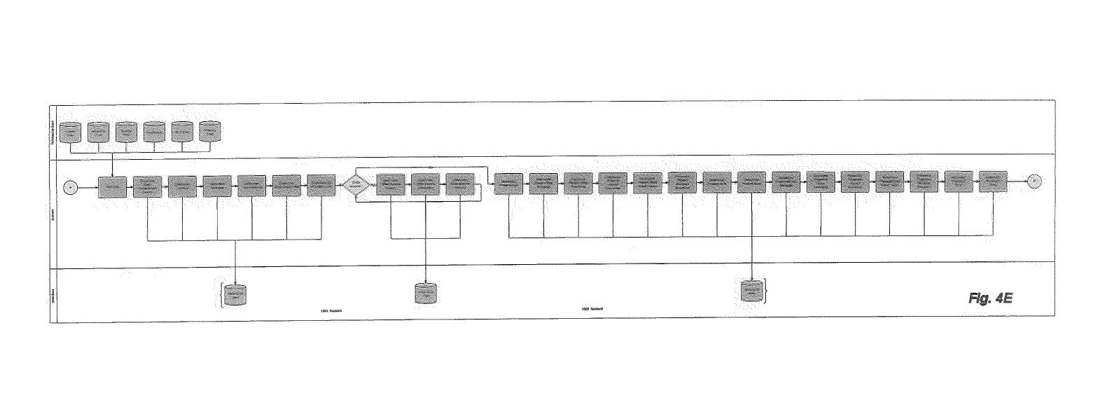

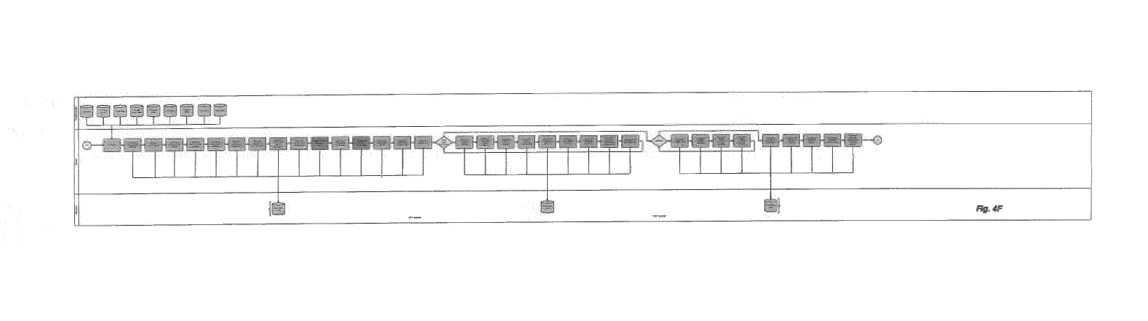

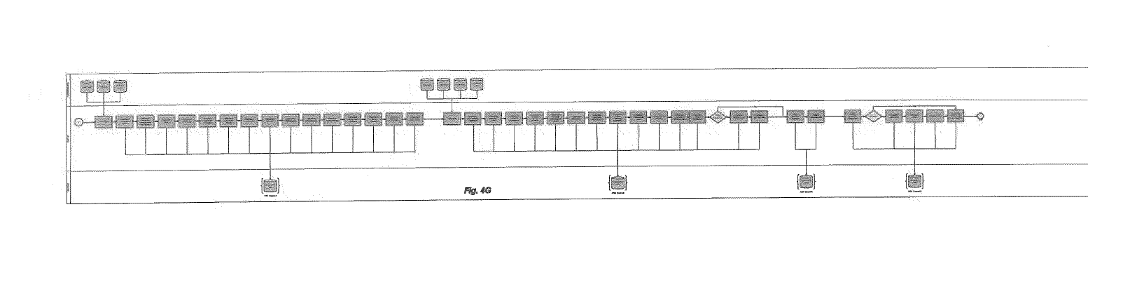

FIGS. 4A-4G depict workflow diagrams of certain processes according to an example implementation of an MAA system performing at least some of the described techniques.

FIG. 4A illustrates an overview of an exemplary implementation of an automated mortgage application process in accordance with at least some of the described techniques. In particular, in the depicted implementation, the overview includes an initiation phase (“Initiate”), in which the user creates an account with the MAA system (“User Sign Up”), provides information in response to “4 Questions,” and verifies the user's identity; the “Automated Mortgage Application” phase in which a complete mortgage application (such as an industry-standard 1003 mortgage application form) may be generated by the MAA system; the “Complete Mortgage Application” phase, in which the information generated by the MAA system for the mortgage application is verified by the user and completed by the MAA system based on such verification; the Lender Application phase, in which the generated mortgage application is submitted to multiple lenders and in which the results of such applications are displayed to the user; and the Closing phase, which in the depicted implementation includes Appraisal, Conditions, Alone Documentation, Notary, and Closing.

FIG. 4B illustrates a portion of an exemplary implementation of an automated mortgage application process in accordance with at least some of the described techniques. In particular, the process portion depicted in FIG. 4B illustrates an overview of data acquisition and synthesis used to generate an industry-standard 1003 mortgage application. In the depicted implementation, data acquisition (such as may be performed by the data acquisition manager 122 of FIG. 1, or the data acquisition manager module 246 of FIG. 2) includes credit report data, financial accounts data, employment data, income data, social media data, company data, real estate Multiple Listing Service (MLS) data, property data, and vehicle data. As discussed elsewhere herein, in various implementations such data acquisition may be paired with intelligent data synthesis (such as may be performed by data synthesis manager 116 of FIG. 1, or by data synthesis manager module 248 of FIG. 2) in order to resolve conflicts between multiple data sources, to estimate various aspects of the user's information based on other data received, etc. For example, the MAA system may provide an estimation of the user's income level based on bank statement information, account balances, spending habits, and other information that is related but not equivalent to income data acquired from the user or data sources directly. Based on the data acquisition, the MAA system analyzes the gathered data to determine particular data points for the generated mortgage application (e.g., a 1003 form).

FIG. 4C illustrates an overview of interactions with third-party vendors and other data source providers used to generate portions of a mortgage application. A processor-based device requests credit report data from one or more credit report vendors by exchanging electronic communications with a computing system associated with each credit report vendor, at least one of which returns a result to the processor-based device. If successful in receiving the credit report data, the processor-based device stores the data; if not, it may terminate the process with respect to the current user. A processor-based device requests financial accounts data from one or more financial account vendors by exchanging electronic communications with a computing system associated with each financial account vendor, at least one of which returns a result to the processor-based device. If successful in receiving the financial account data, the processor-based device stores the data; if not, it may terminate the process with respect to the current user. A processor-based device requests employment data from one or more employment data vendors by exchanging electronic communications with a computing system associated with one or more employment data vendors, at least one of which returns a result to the processor-based device. If successful in receiving the employment data, the processor-based device stores the data. A processor-based device requests income data from one or more income data vendors by exchanging electronic communications with a computing system associated with each income data vendor, at least one of which returns a result to the processor-based device. If successful in receiving the income data, the processor-based device stores the data. A processor-based device requests social media accounts data from one or more social media account vendors by exchanging electronic communications with a computing system associated with each social media account vendor, at least one of which returns a result to the processor-based device. If successful in receiving the social media accounts data, the processor-based device stores the data. A processor-based device requests MLS data from one or more MLS data vendors by exchanging electronic communications with a computing system associated with each MLS data vendor, at least one of which returns a result to the processor-based device. If successful in receiving the MLS data, the processor-based device stores the data. A processor-based device requests property data from one or more property data vendors by exchanging electronic communications with a computing system associated with each property data vendor, at least one of which returns a result to the processor-based device. If successful in receiving the property data, the processor-based device stores the data. A processor-based device requests company data from one or more company data vendors by exchanging electronic communications with a computing system associated with each company data vendor, at least one of which returns a result to the processor-based device. If successful in receiving the company data, the processor-based device stores the data. A processor-based device requests automobile data from one or more automobile data vendors by exchanging electronic communications with a computing system associated with each automobile data vendor, at least one of which returns a result to the processor-based device. If successful in receiving the automobile data, the processor-based device stores the data.

FIG. 4D illustrates an overview of data acquisition and synthesis used to generate sections 1-4 of a mortgage application. A processor-based device synthesizes system data and user data to generate information for a portion of the mortgage application, such as for Section 1 of an industry-standard 1003 form. In the depicted implementation, based on such data the processor-based device determines the applicant user's name; the particular mortgage for which the applicant user intends to apply; and the amount of loan associated with respect to that particular mortgage. A processor-based device further synthesizes user data, MLS data, property data and accounts data to generate information for another portion of the mortgage information, such as for Section 2 of an industry-standard 1003 form. In the depicted implementation, based on such data the processor-based device determines the subject property address, the number of units, the legal description of the subject property, the year the property was constructed, the purpose of the loan to be applied for, the intended property use, the identity of the titleholder and the manner in which the title is held, the land ownership type, and the source of the down payment. If it is determined that the loan being sought is a construction loan, the processor-based device further determines the year in which the property lot was acquired, the original cost, the amount of any existing liens, the present value of the property lot, the cost of improvements, and the resulting total. A processor-based device further synthesizes user data, social media data, credit data and property data to generate information for another portion of the mortgage application, such as for Section 3 of an industry-standard 1003 form. In the depicted implementation, based on such data the processor-based device determines the applicant user's social security number, home, date of birth, years of schooling, marital status, the existence and number of any dependents, present address, whether the user currently owns or rents property at that address, and the user's mailing address. If the applicant user has lived at the determined current address for less than two years, the processor-based device further determines one or more of the user's former addresses and whether they owned or rented property each of those respective addresses. A processor-based device further synthesizes social media data, company data and credit data to generate information for another portion of the mortgage application, such as for Section 4 of an industry-standard 1003 form. In the depicted implementation, based on such data of the processor-based device determines the applicant user's employer name, employer address, whether the applicant user is self-employed, how many years the user has been employed by the current employer, the field of employment, the user's position and title, the type of business, and a contact telephone number for the employer. If the applicant user has been employed for less than two years, or if additional employers are indicated, the processor-based device may additionally determine the applicant user's monthly income based on such information. In other implementations, such estimates as to the Applicant user's income may be derived in various manners or from other sources.

FIG. 4E illustrates an overview of data acquisition and synthesis used to generate section 5 of a mortgage application. A processor-based device synthesizes system data, accounts data, income data, credit data, MLS data and property data to generate information for a portion of the mortgage application, such as for Section 5 of an industry-standard 1003 form. In the depicted implementation, based on such data the processor-based device determines base employment income, overtime income, bonuses, commissions, dividends and interest, and rental income. If additional income is indicated, the processor-based device further determines other income sources, a description of those other income sources, and an amount attributable to those other income sources. Also based on such data, the processor-based device may determine the user's present rent, present first mortgage, present other financing, present hazard insurance, present real estate taxes, present mortgage insurance, present homeowner's association fees, and other current circumstances relevant to the applicant user; as well as monetary amounts associated with the proposed first mortgage, proposed other financing, proposed hazard insurance, proposed real estate taxes, proposed mortgage insurance, proposed homeowner's association fees, and other circumstances relevant to the proposed mortgage.

FIG. 4F illustrates an overview of data acquisition and synthesis used to generate section 6 of a mortgage application. A processor-based device synthesizes user data, accounts data, credit data, social media data, property data, automobile data and asset data to generate information for a portion of the mortgage application, such as for Section 6 of an industry-standard 1003 form. In the depicted implementation, based on such data the processor-based device determines the amounts of held cash deposits; bank account names, account numbers and account balances; the names, numbers, description and values associated with any stocks and bonds held by the applicant user; the value of any life insurance associated with the applicant user; the values of any retirement funds held by the applicant user; the net worth of any businesses owned or operated by the applicant user; the value and existence of any owned automobiles; and other assets. If real estate is owned by the applicant user, the processor-based device further determines, with respect to each owned property, the property address, status, type, present market value, mortgage and liens, gross rental income, mortgage payments, insurance, maintenance fees, taxes, and net rental income. If liabilities are indicated, the processor-based device further determines, for each indicated liability, and associated name, address, account number, and monthly payment; and may still further determine any maintenance payments, job-related expenses, alternate names, creditors associated with such alternate names, and credit account numbers associated with such alternate names.

FIG. 4G illustrates an overview of data acquisition and synthesis used to generate sections 7-10 of a mortgage application. A processor-based device synthesizes user data, MLS data and property data to generate information for a portion of the mortgage application, such as for Section 7 of an industry-standard 1003 form. In the depicted implementation, based on such data of the processor-based device determines (with respect to the mortgage currently being sought) a purchase price; alterations, improvements and/or repairs; relevant land; refinancing costs; estimated prepaid costs; estimated closing costs; PMI and MIP; estimated discount; subordinate amounts; closing costs; excluded loan amounts; PMI and MIP financing; and the total loan amount. A processor-based device further synthesizes user data, asset data, credit data and property data to generate information for a portion of the mortgage application, such as for Section 8 of an industry-standard 1003 form. In the depicted implementation, also based on such data the processor-based device determines any outstanding judgments associated with the user; bankruptcies within the past seven years; any properties foreclosed upon; whether the user is party to any lawsuits; whether the user has been indirectly foreclosed upon, or similar occurrences; whether the user is delinquent with respect to any current or past obligations; any separate maintenance obligations associated with the user; whether the down payment from the user is being borrowed from another party; any co-makers on the property note; a current citizenship or resident alien status of the user; the primary residence of the user; the intended property use; and the manner in which title is held. Also based on such data, the processor-based device further generates information for another portion of the mortgage application, such as for Section 9 of an industry-standard 1003 form. In the depicted implementation, such information includes collecting the borrower's signature and current date. Also based on such data, the processor-based device further generates information for another portion of the mortgage application, such as for Section 10 of an industry-standard 1003 form. In the depicted implementation, such information includes the applicant user's ethnicity, race, gender, and whether such information was provided directly by the applicant user.

### Modifications

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other systems, not necessarily the exemplary system generally described above. In certain implementations, additional components, modules or functionality may be provided as part of other components or modules described above

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. Those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Various methods and/or algorithms have been described. Some or all of those methods and/or algorithms may omit some of the described acts or steps, include additional acts or steps, combine acts or steps, and/or may perform some acts or steps in a different order than described. In addition, while various operations may be illustrated as being performed in a particular manner (e.g., in serial or in parallel) and/or in a particular order, those skilled in the art will appreciate that in other implementations the operations may be performed in other orders and in other manners. Some of the method or algorithms may be implemented in software routines. Some of the software routines may be called from other software routines. Software routines may execute sequentially or concurrently, and may employ a multi-threaded approach.

The various implementations described above can be combined to provide further implementations. Aspects of the implementations can be modified to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method of operation of a mortgage application automation system, the mortgage application automation system including at least one processor and at least one nontransitory processor-readable medium communicatively coupled to the at least one processor and which stores at least one of processor-executable instructions or data, the method comprising:
receiving, by the at least one processor via one or more first electronic communications sent over one or more computer networks from a client computing system of a first applicant, a set of applicant identity information, the applicant identity information specifying an identity of the first applicant;
receiving, by the at least one processor via one or more second electronic communications sent over the one or more computer networks, a set of real property identity information, the real property identity information specifying an identity of a first parcel of real property;
receiving, by the at least one processor via one or more third electronic communications sent over the one or more computer networks, a set of applicant authorization information, the applicant authorization information including an indication that the first applicant has authorized retrieval of first applicant related personal information;
retrieving, by the at least one processor via one or more fourth electronic communications sent over the one or more computer networks, supporting information for the first applicant from a plurality of third-party data sources; and
generating, by the at least one processor, at least one mortgage application for the first applicant and the first parcel of real property based at least in part on the retrieved supporting information for the first applicant.

2. The method of claim 1, further comprising:
electronically transmitting the generated mortgage application for the first applicant and the first parcel of real property to at least one of a plurality of third-party lenders for review.

3. The method of claim 2, further comprising:
electronically receiving, via one or more additional electronic communications sent over the one or more computer networks, multiple loan offers from the at least one third-party lender based on the generated mortgage application for the first applicant and on the first parcel of real property;
selecting, by the at least one processor, one or more of the multiple loan offers from the at least one third-party lender, the selecting of the one or more loan offers being based at least in part on one or more criteria associated with the first applicant;
displaying, via the one or more computer networks, information to the first applicant indicative of the selected one or more loan offers.

4. The method of claim 3 wherein electronically transmitting the generated mortgage application to the at least one third-party lenders includes electronically transmitting the generated mortgage application to each of at least one processor-based systems respectively associated with each of the at least one third-party lenders.

5. The method of claim 3 wherein the at least one third-party lender includes a third-party lender that offers a first loan identified by the first applicant prior to the generating of the mortgage application, and wherein the method further comprises associating the one or more criteria with the first applicant by the at least one processor based at least in part on the identification of the first loan by the first applicant.

6. The method of claim 2 wherein electronically transmitting the generated mortgage application to the at least one third-party lender for review includes electronically transmitting an identical mortgage application to each of multiple third-party lenders.

7. The method of claim 6, wherein electronically transmitting the identical mortgage application to each of the multiple third-party lenders includes electronically transmitting the identical mortgage application to each of the multiple third-party lenders based on a single interaction of the first applicant with a graphical user interface provided at least in part by the at least one processor.

8. The method of claim 6, wherein electronically transmitting the identical mortgage application to each of the multiple third-party lenders includes electronically transmitting the identical mortgage application to each of the multiple third-party lenders based on multiple interactions of the first applicant with a graphical user interface provided at least in part by the at least one processor, each of the multiple interactions being respectively associated with one of the multiple third-party lenders.

9. The method of claim 1, further comprising:
adjusting, by the at least one processor, an amount of supporting information required for the mortgage application based at least in part on an assessment by the at least one processor of a group that includes one or more of a quality of at least one of the third-party data sources from which supporting information is received and a quality of at least one piece of the supporting information retrieved from at least one of the third-party data sources.

10. The method of claim 1 wherein retrieving supporting information for the first applicant from the plurality of third-party data sources includes retrieving multiple conflicting pieces of data associated with the first applicant from multiple of the plurality of third-party data sources, and wherein generating the at least one mortgage application for the first applicant in the first parcel of real property includes resolving one or more conflicts between the multiple conflicting pieces of data associated with the first applicant.

11. A non-transitory computer-readable medium having stored contents that, when executed, configure a computing system to:
receive, by the configured computing system via one or more electronic communications transmitted over one or more computer networks from a client computing system associated with an applicant, a set of applicant identity information that includes one or more indications of an identity of the applicant;
receive, by the configured computing system via one or more electronic communications transmitted over the one or more computer networks, a set of real property identity information, the real property identity information specifying an identity of a first parcel of real property;
responsive to the set of applicant identity information, obtain, by the configured computing system via one or more electronic communications transmitted over the one or more computer networks, a set of applicant authorization information, the applicant authorization information including an indication that the applicant has authorized retrieval of first applicant related personal information;
retrieve, by the configured computing system via one or more electronic communications transmitted over the one or more computer networks, supporting information from a plurality of third-party data sources;
generate, by the configured computing system, a mortgage application associated with the applicant and with the first parcel of real property based at least in part on the retrieved supporting information;
provide, by the configured computing system via one or more electronic indications transmitted over the one or more computer networks, the generated mortgage application to at least one of a plurality of third-party lenders; and
display, by the configured computing system via the one or more computer networks and based on the providing of the generated mortgage application to the at least one third-party lender, at least one loan offer to the applicant.

12. The non-transitory computer-readable medium of claim 11, wherein the stored contents further configure the computing system to:
receive multiple loan offers from the at least one third-party lender based on the generated mortgage application; and
select at least one of the multiple loan offers from the at least one third-party lender, the selecting of the at least one loan offer being based at least in part on criteria associated with the applicant;
wherein displaying the at least one loan offer to the applicant includes displaying information to the first applicant indicative of the selected one or more loan offers.

13. The non-transitory computer-readable medium of claim 12 wherein the at least one third-party lender includes a third-party lender that offers a first loan identified by the applicant prior to the generating of the mortgage application, and wherein the stored contents further configure the computing system to associate the criteria with the applicant based at least in part on the identification of the first loan by the applicant.

14. The non-transitory computer-readable medium of claim 11 wherein providing the generated mortgage application to the at least one third-party lender includes transmitting an identical mortgage application to each of multiple third-party lenders.

15. The non-transitory computer-readable medium of claim 11 wherein the stored contents further configure the computing system to:
adjust an amount of supporting information required for the mortgage application based at least in part on an assessment by the configured computing system of a group that includes one or more of a quality of at least one of the third-party data sources from which supporting information is received and a quality of at least one piece of the supporting information retrieved from at least one of the third-party data sources.

16. The non-transitory computer-readable medium of claim 11 wherein the stored contents further configure the computing system to resolve one or more conflicts between multiple conflicting pieces of data included in the retrieved supporting information.

17. A system, comprising:
one or more processors; and
at least one memory, the memory including instructions that, upon execution by at least one of the one or more processors, cause the system to:
receive a set of applicant identity information that includes one or more indications of an identity of an applicant;
receive a set of real property identity information specifying an identity of a first parcel of real property;
responsive to the set of applicant identity information, obtain a set of applicant authorization information that includes an indication that the applicant has authorized retrieval of personal information regarding the applicant;
retrieve supporting information from a plurality of third-party data sources;
generate, based at least in part on the retrieved supporting information, a mortgage application associated with the applicant and with the first parcel of real property;
electronically transmit the generated mortgage application to at least one of a plurality of third-party lenders; and
display, based at least in part on electronically transmitting the generated mortgage application, at least one loan offer to the applicant.

18. The system of claim 17, wherein the instructions further cause the system to:
receive multiple loan offers from the at least one third-party lender based on the generated mortgage application; and
select, based at least in part on criteria associated with the applicant, the at least one loan offer from the multiple loan offers for display to the applicant.

19. The system of claim 18 wherein the at least one third-party lender includes a first third-party lender that offers a first loan identified by the applicant prior to the generating of the mortgage application, and wherein the instructions further cause the system to associate the criteria with the applicant based at least in part on the identification of the first loan by the applicant.

20. The system of claim 17 wherein electronically transmitting the generated mortgage application to the at least one third-party lender includes electronically transmitting an identical mortgage application to each of multiple third-party lenders.

21. The system of claim 17 wherein the instructions further cause the system to resolve one or more conflicts between multiple conflicting pieces of data included in the retrieved supporting information.
